(19) United States
(12) Patent Application Publication
(10) Pub. No.: US 2004/0048967 A1
(43) Pub. Date: Mar. 11, 2004

(54) Process for producing thermoplastic resin composition and thermoplastic resin composition obtained thereby

(76) Inventors: Ryuzo Tomomatsu, Chiba (JP); Takahiro Hirai, Chiba (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/362,517

(22) PCT Filed: Sep. 6, 2001
(86) PCT No.: PCT/JP01/07730

(30) Foreign Application Priority Data
Sep. 7, 2000 (JP) 2000-271724
Oct. 5, 2000 (JP) 2000-305649
Feb. 28, 2001 (JP) 2001-55091
Aug. 8, 2001 (JP) 2001-240869

(51) Int. Cl. C08K 3/34

(52) U.S. Cl. 524/451

(57) ABSTRACT

A process for producing a composition containing at least a thermoplastic resin and/or rubber and a filler which comprises melt kneading at least a thermoplastic resin and/or rubber and a compressed filler by the use of a kneading extruder which is composed of a twin-screw kneading portion equipped with screws each having an L/D (ratio of length to diameter) of at least 12 in a twin-screw portion, and equipped at an end of the twin-screw portion with a damming structure, and of a single-screw extrusion portion. It is made possible by the above process to produce in high productivity, a filler-containing composition well balanced in physical properties.

### TECHNICAL FIELD

The present invention relates to a process for producing a thermoplastic resin composition which is excellent in the balance among its physical properties, contains a filler in a high concentration and is well suited for use as a master batch; and a thermoplastic resin composition which is obtained by the foregoing process. The thermoplastic resin composition according to the present invention is useful in the fields of electrical home appliances, automobiles and office automation equipment, and in the fields requiring a master batch.

### BACKGROUND ART

There has hitherto been widely used a filler charge method as a means for imparting rigidity to a plastic material particularly in the fields of electrical home appliances, automobiles and office automation equipment, and there are growing in recent years, steady demands for improvement in physical properties of a plastic material and for curtailment of its cost.

In such circumstance, there is proposed a method which comprises dry blending a master batch containing a filler and a neat resin, and molding the blend by means of injection molding, extrusion molding or the like. It is effective to employ a fine filler in order to improve the physical properties of a plastic material. However, the use of a finely pulverized filler brings about the problems which involve a low bulk specific gravity, a lowered kneading speed (throughput of the resin composition to be obtained) at the time of melt kneading the filler and a resin, and the deterioration in the quality stability of the resin composition accompanying the classification operation and in workability, and which are more serious than those in the case of using a non-pulverized filler.

For instance, in the case of talc-filled polypropylene that is widely used as a material for interior and outerior members of an automobile and electrical home appliances, an attempt is made to solve the above-mentioned problems by using compressed talc for the purpose of increasing the bulk specific gravity of a fine filler {refer to Japanese Patent Application Laid-Open Nos. 306261/1992 (Heisei-4)}. Nevertheless, since the compressed talc is inferior to non-compressed talc in the dispersibility at the time of kneading along with a resin, it can not be said that a molded article composed of a resin composition produced by kneading compressed talc has satisfactory physical properties, though there exists no problem in external appearance.

On the other hand, there is well known a process for producing a resin composition by the use of a master batch filled in with ordinary talc, that is, non-pulverized filler in a high concentration for the purpose of curtailing the product cost, wherein the master batch is diluted with a neat resin at the time of injection molding or extrusion molding. There is available a process for producing a master batch by kneading a non-pulverized talc by the use of a twin-screw extruder of meshing in the same direction or a single-screw extruder. In this case, though the dispersibility and the like of the talc is improved, the physical properties thereof still remain unimproved because of the limitation on kneading the talc in a high concentration and further a large particle diameter of the talc.

The production of a resin composition by using a master batch filled in with talc in a high concentration for the purpose of curtailing the product cost involves such problems that \mathring{1} the production of a master batch filled in with talc in a high concentration causes a problem of kneading stability with a decrease in yield; \mathring{2} the high concentration of the filler therein lowers the dispersibility of the filler, thus deterioraing the physical properties of a molded article at the time of molding by diluting the master batch with a neat resin; \mathring{3} in the field which requires a high performance product and in which use is made of a fine filler with a small particle diameter, the finer the filler, the worse the dispersibility of the filler with a result that the physical properties of the product are deteriorated; and the like problems.

The problems such as the foregoing worsened dispersibility of the filler become further serious, as high fluidity base polypropylene is adopted, accompanying steady increase in the demand for a high fluidity base material, thus bringing about in particular, the problem of deterioration in impact properties of high impact materials.

Though a master batch is adopted in part in the field not requiring strict physical properties, the master batch having a performance result has been limited to that containing a filler having favorable dispersibility along with a large particle diameter or that containing a filler in a low concentration.

It being so, if the above-mentioned problems can be solved so that a master batch is obtained which has physical properties comparable to those of a whole blend, it is made possible to cope with such a field as requiring strict performance as well as high fluidity and at the same time, to contrive enhancement of the yield at the time of producing a master batch and high concentration of the master batch, thereby enabling further curtailment of the production cost.

There are adopted other processes for producing a master batch, including a gelation process and a batch-wise process such as kneading with a Banbury mixer. However, the gelation process involves such problems that the production time is prolonged when talc has a small particle diameter, said process is greatly influenced by the MI (melt index) of a base resin, the particle diameter of talc, the amount thereof to be used and the like and the talc has insufficient dispersibility, thereby making it impossible to produce a master batch imparted with a desirable chemical composition.

In the gelation process, which makes use of an agitator, and thus makes it difficult to disperse a filler in a master batch to be produced, the dispersibility thereof is enhanced by subjecting the filler to an expensive surface treatment.

In the case of producing a master batch by means of a gelation process, usable resin is restricted to one species only, since plural species of resins, when used, render it insufficient to disperse a filler and compatibilize the resins with one another. In addition, in the case of producing a master batch by means of a gelation process, a pigment, when added thereto, needs a considerable time for the cleaning work of the production machinery and equipment, whereby a master batch to which a pigment is added is not produced by a gelation process.

Accordingly, a master batch produced by a gelation process has a simple blending composition and is exemplified by a master batch composed of polypropylene and talc, which is used mainly for the production of a conventional trim. A master batch produced thereby is also adopted to instrument panel-based parts which need post addition of rubber. However, since the master batch can not be charged with rubber, block polypropylene blended with rubber is used as polypropylene based resin to be used for diluting a master batch. For this reason, kneading cost is required also for preparing polypropylene based resin for dilution, thereby bringing about the problem of decreasing the effect on the curtailment of production cost. On the other hand, kneading with a Banbury mixer is not widespread, since it is problematic in productivity (workability) and a high production cost and besides, limitation is put on the kneading of fine filler to a high concentration.

### DISCLOSURE OF THE INVENTION

A general object of the present invention, which has been made in the light of the above-mentioned circumstances, is to provide a process for producing, with favorable productivity, a thermoplastic resin composition or a rubber composition each containing a fine filler in a high concentration; and to provide a composition which is produced by the foregoing process and excellent in the balance among the physical properties.

Another object of the present invention is to provide a process for producing, with favorable productivity, a thermoplastic resin composition which contains a fine filler in a high concentration and which is well suited as a master batch; and to provide a thermoplastic resin composition which is produced by the foregoing process and which is excellent in the balance among the physical properties.

Still another object of the present invention is to provide a process for producing a thermoplastic resin composition having physical properties comparable to those of a resin composition which is produced by an ordinary kneading without the use of a master batch; and to provide a thermoplastic resin composition which is produced by the foregoing process and which is excellent in the balance among the physical properties.

Further object of the present invention is to provide a process for producing at a low cost, a material for molded articles which is capable of coping with the production of a molded article necessitating complicated blending; and also to provide molded articles produced by molding the above-mentioned material for molded articles.

As a result of intensive and extensive research accumulated by the present inventors in order to solve the above-mentioned problems involved in the prior arts, it has been found that a thermoplastic resin composition and/or a rubber composition are obtained which are enhanced in productivity (throughput of the composition, quality stability at a feed portion accompanying classification of a filler, and workability) without causing poor dispersibility of the filler accompanying enhanced bulk specific gravity or deteriorating the physical properties, by kneading extruding at least a thermoplastic resin and/or rubber and a compressed filler with a specific kneading extruder.

In addition, it has been found that a thermoplastic resin composition is obtained which is enhanced in productivity (throughput of the composition, quality stability at a feed portion accompanying classification of a filler and workability) without causing poor dispersibility of the filler accompanying enhanced bulk specific gravity or deteriorating the physical properties, by kneading extruding a thermoplastic resin and a specific filler at a specific ratio in the presence of an organic peroxide through the use of a specific kneading extruder. That is to say, the problem that a filler, especially an inorganic filler, when filled in a high concentration, increases the variation in the throughput of the composition can be eliminated, that is, the variation in the throughput can be reduced by adding an organic peroxide, whereby generation of surging phenomenon is precluded, thus enabling the yield to be improved and pellet size to be uniformized. Moreover it has been found that the use of the resultant thermoplastic resin composition as a master batch enhances the dispersibility of an inorganic filler when diluted with a neat resin, thereby preventing the deterioration of the physical properties of molded articles.

Further, it has been found that there is obtainable a thermoplastic resin composition having physical properties comparable to those of a resin composition which is produced by an ordinary kneading without the use of a master batch, by a method comprising, at the time of producing a thermoplastic resin composition and/or a rubber composition, using at least one specific master batch formed by melt kneading at least a thermoplastic resin and/or rubber and a compressed filler or at least two master batches containing at least one specific master batch just mentioned, and dry blending any of the foregoing master batches and one or at least two neat resin.

Furthermore, it has been found that there is obtainable a material for molded articles which is well suited for producing molded articles such as automobile parts and electrical home appliances in the case where a material for molded articles is produced by blending (A) a master batch comprising at least two species selected from the group consisting of thermoplastic resins and rubber and a compressed filler; and (B) at least one species selected from the group consisting of thermoplastic resins and rubber, wherein the mass of the component (A) and the mass of the component (B) satisfy a specific relationship. The present invention has been accomplished by the above-mentioned findings and information.

Specifically, the present invention provides the following.

A process for producing a thermoplastic resin composition or a rubber composition which comprises melt kneading at least a thermoplastic resin and/or rubber and a filler by the use of a kneading extruder, wherein a compressed filler is used as a filler and the kneading extruder is composed of a twin-screw kneading portion equipped with screws each having an L/D (ratio of length to diameter) of at least 12 in a twin-screw portion, and equipped at an end of the twin-screw portion with a damming structure, and of a single-screw extrusion portion (Invention I);

A process for producing a thermoplastic resin composition which comprises kneading extruding 50 to 10 parts by mass of a thermoplastic resin and 50 to 90 parts by mass of a compressed filler having a bulk specific gravity of at least 0.4 making a total of 100 parts by mass in the presence of 0.008 to 0.2 part by mass of an organic peroxide by the use of a single-screw kneading extruder, a twin-screw kneading extruder or a kneading extruder comprising a twin-screw kneading portion and single-screw extrusion portion (Invention II);

A process for producing a thermoplastic resin composition which comprises dry blending a master batch formed by melt kneading at least a thermoplastic resin and/or rubber and a compressed filler; and at least two neat resins (Invention III-1);

A process for producing a thermoplastic resin composition which comprises dry blending at least two master batches each formed by melt kneading at least a thermoplastic resin and/or rubber and a filler; and at least two neat resins, wherein a compressed filler is used as a filler in at least one of the aforesaid at least two master batches (Invention III-2); and

A process for producing a material for molded articles by blending (A) a master batch comprising at least two species selected from the group consisting of thermoplastic resins and rubber and a compressed filler; and (B) at least one species selected from the group consisting of thermoplastic resins and rubber, wherein A the mass of the component (A))/[A+B{the mass of the component (B)}] is in the range of 0.1 to 0.6 (Invention IV).

### BRIEF DESCRIPTION OF THE DRAWINGS

FIG. 1 is a cross-sectional view illustrating one example of a kneading extruder to be used in the present invention;

FIG. 2 is a cross-sectional view taken in the line A-A of FIG. 1; and

FIG. 3 is a cross-sectional view taken in the line B-B of FIG. 1, wherein 1: casing, 2: screw portion, 3: first shaft, 4: second shaft, 5: extended shaft porion, 6: twin screw portion, 7: single screw portion, 8: material feed port, 9: end portion, 10: discharge port

### THE MOST PREFERRED EMBODIMENT TO CARRY OUT THE INVENTION

Examples of the thermoplastic resin to be used in the Invention I include polyolefin base resin such as polypropylene and polyethylene, polystyrene resin, polycarbonate resin, polyacetal resin, polyester resin and polyamide resin. Polypropylene is exemplified by homopolypropylene, random polypropylene and block propylene. Polyethylene is exemplified by homopolyethylene LDPE (low density polyethylene) and LLDPE (linear low density polyethylene). Examples of the rubber include natural rubber and synthetic rubber exemplified by olefinic rubber such as ethylene propylene rubber and ethylene octene-1 rubber, styrene-butadiene rubber, nitrile-butadiene rubber, acrylonitrile-butadiene rubber and chloroprene rubber. The following description relates mainly to a thermoplastic resin, but is also applicable to rubber.

Talc is preferred as a filler, but other compressed fillers can be used instead of talc which is problematic in productivity because of its low bulk specific gravity. In particular, there is cited as an example, wood powder on which investigation is increasingly made as an environmental countermeasure. Examples of other fillers include calcium carbonate, magnesium hydroxide, kaolin (aluminum silicate), silica, perlite, sericite, diatomaceous earth, calcium sulfite, mica and potassium titanate.

The average particle diameter of a filler prior to be compressed is preferably at most 15 μm as measured by Laser system measuring method. The average particle diameter thereof, when being larger than 15 μm, brings about difficulty in forming secondary agglomerates by means of compression and a decrease in the effect on enhancing the bulk specific gravity. Taking into consideration that the productivity (throughput of the composition, quality stability, workability) is enhanced by increasing the bulk specific gravity, the average particle diameter of a filler prior to be compressed is preferably at most 8 μm, particularly preferably at most 6 μm.

In the Invention I, use is made of a filler in which the bulk specific gravity is enhanced by compressing the same. The bulk specific gravity is represented by {weight of a filler (g)/volume of the filler (cm³)}. The bulk specific gravity of a compressed filler is in the range of preferably 0.4 to 1.5, more preferably 0.55 to 1.5, particularly preferably 0.75 to 1.5. When the aforesaid bulk specific gravity is lower than 0.4, a filler is more prone to be classified, the effect on enhancing the throughput of the composition becomes insufficient, and the filler which has been compressed in a preblending step of a feed material is liable to cracking. What is more, when the bulk specific gravity is unreasonably low, there is a tendency to infusibilize a resin in the case of high concentration kneading and to spout the filler from a die. On the contrary, the higher the bulk specific gravity, the easier to fusibilize the filler, thus enabling high concentration kneading. However, when the bulk specific gravity is higher than 1.5, there is a fear of worsened dispersibility of the filler at the time of kneading. The shape of a compressed filler is preferably in the form of particulate instead of the form of chip with a view to improve the dispersibility. By “the form of chip” is meant the form of rectangular parallelopiped having a major axis of 2 to 10 mm, approximately and a minor axis of 2 to 5 mm, approximately. By “the form of particulate” is meant the form which is other than the form of chip and which has a major axis and a minor axis almost equal to each other.

The compressed filler is not specifically limited in its production process, but can be produced by a pressurizing treatment or depressurizing treatment. The pressurizing treatment can be carried out with a roller compactor (manufactured by Kurimoto Industrial Co., Ltd. under the trade name MRCP), which is in the form of cantilever having two compressing rolls wherein one of them is capable of regulating the bulk specific gravity by its pressure. The shape of the compressed filler can be regulated to the form of particulate or chip by means of a granulator in the post step. As a filler, talc most preferable in view of capability of meeting the aforesaid requirements of average particle diameter, bulk specific gravity and shape.

The filling quantity (content thereof in the thermoplastic resin composition or rubber composition) of a compressed filler can be made to 1 to 90% by mass. The thermoplastic resin composition or rubber composition containing a filler having a high filling quantity exceeding 50% by mass is usable as a master batch for the purpose of curtailing the product cost, but it is also usable as a master batch even in the case of a low filling quantity less than 50% by mass. In the case of being used as a master batch, said composition as a master batch is diluted by dry blending, for instance, with neat polypropylene on molding such as injection molding, so that the composition is molded. In this case, the physical properties of the master batch as obtained by the production process of the Invention I are not deteriorated even if a molding machine is not equipped with a mixing nozzle. However, in the case of coloring the composition on molding by using a pigment containing master batch, a molding machine is preferably equipped with a mixing nozzle to prevent tendency to cause unevenness in dispersibility of the pigment.

The composition relating to the Invention I can properly and optionally be incorporated with any of an organic peroxide, anti-oxidant, weatherproofing agent and pigment according to the purpose of use of the thermoplastic resin composition.

In the production process of the Invention I, use is made of a specific kneading extruder which comprises a twin-screw kneading portion equipped with screws each having an L/D (ratio of length to diameter) of at least 12 in a twin-screw portion, and equipped at an end of said portion with a damming structure; and a single-screw extrusion portion (Invention I). The L/D value at the twin-screw portion is preferably at least 20, more preferably at least 25. The L/D value, when being less than 12, leads to insufficient dispersion of the filler, thus making it impossible to fill a filler in the thermoplastic resin composition in high concentration and good dispersibility. The number of revolutions of the screw can be made to be 10 to 1500 rpm according to the characteristics of the composition to be produced. For instance, when producing a high fluidity composition for the injection purpose, the number of revolutions is preferably higher because of its low viscosity requiring to assure a shear stress. On the other hand, when producing a composition for the extrusion purpose, the number of revolutions is preferably lower due to liability to molecular cleavage, causing the viscosity to be lowered. It is preferable to impart screws at a twin-screw portion with the number of revolutions different from each other rather than the same number thereof from the aspect of kneading effect. Usually, the ratio of the number of revolutions is made to 1:1.1, approximately.

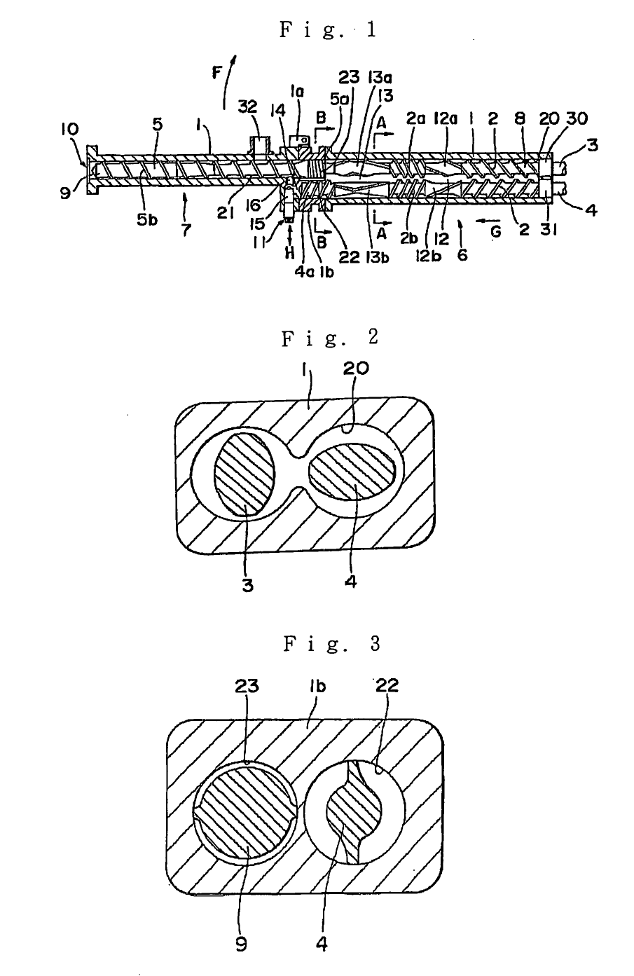

The damming structure is such that a screw groove at the end of the twin-screw portion is formed shallowly so that the clearance from the casing (refer to FIG. 1 described after) is minimized and the pitch is made fine. It is enabled by the damming structure to regulate the flow rate of passing blending components to a minimum and to sufficiently conduct kneading.

Taking into consideration the dispersion of the filler and throughput of the composition, the screw at the twin-screw kneading portion is preferably of the type of non-meshing and different rotational direction. Preferably, the screw is of a rotor type and has a double threaded structure as illustrated in FIG. 2. The screw and rotor are each of segment type, which enable at need to regulate kneading by means of rotor position, L/D, tip clearance and the like.

Preferably, the twin-screw kneading portion is equipped at the end thereof with a function of regulating the resin quantity so as to enable to regulate the retention time of the blending components according to the characteristic requirements of the composition. Such function is exemplified by regulating function with an orifice. The kneading extruder is not always limited to an integral structure between the twin-screw kneading portion and the single-screw extrusion portion. Instead, it may be of a tandem type provided that the foregoing requirements are satisfied, but is preferably of integral structure therebetween.

There is usable as a kneading extruder in the Invention I, the continuous kneading extruding equipment as illustrated in FIGS. 1 to 3 and described in Japanese Patent Application Laid-Open No. 88926/1995 (Heisei-7). The equipment is equipped with a first shaft 3 housed in a metallic casing 1 and a second shaft 4 shorter than the former, wherein blending components supplied at the base portion (on the right-hand in the figure) are melted, kneaded, sent to the tip side and then discharged.

FIG. 1 points out a cross sectional view of a plan of the equipment, FIG. 2 shows a cross sectional view taken in the line A-A of FIG. 1, and FIG. 3 indicates a cross sectional view taken in the line B-B of FIG. 1. As illustrated in FIG. 1, the casing 1 is constituted wholly in cylindrical form, and divided into two portions at approximately central part. The divisional portion is rotatably supported with a hinge 1a, is equipped with an intervening connection member 1b as another member, and can be bent towards the direction of the arrow F.

In the casing 1, are formed a round sectioned cylinder 21, a cocoon sectioned cylinder 20 connecting two round sectioned cylinders, and two bearing cylinders 22, 23 that are formed in the connection member 1b. In the cocoon sectioned cylinder 20 are arranged in parallel a first shaft 3 and a second shaft 4 which form a screw portion 2, and are fitted into the casing 1 via screw base portions 30, 31. The base end portion of the first shaft 3 and the second shaft 4 is inserted in a gear box (not shown in the drawing) which is installed outside the casing 1, and supported with a bearing in a freely rotatable manner.

A transmitting screw portion 4a at the end of the second shaft 4 is retained at a prescribed position by a molten resin intervening between the transmitting screw portion 4a and the bearing cylinder 22, and thus the second shaft 4 is wholly supported in a freely rotatable manner. Likewise, a transmitting screw portion 5a at the middle of the first shaft 3 is retained at a prescribed position by a molten resin intervening between the transmitting screw portion 5a and the bearing cylinder 23, and thus the first shaft 3 is wholly supported in a freely rotatable manner.

The middle portions of the first shaft 3 and the second shaft 4 are in opposition to each other to prevent contact, and mixing rotor portions 12, 13 each in a pair are placed midway of the shafts. The mixing rotor portions 12, 13 are each composed of a first rotor portions 12a, 12b in opposition and a second rotor portions 13a, 13b, each of the rotor portions being formed in positions apart from each other as shown in the FIG. A second screw 2a is formed between the first rotor portion 12a and the second rotor portion 13a, and a second screw 2b is formed between the first rotor portion 12b and the second rotor portion 13b.

The first shaft 3 has an extended shaft portion 5, which is housed in the round sectioned cylinder 21 in a freely rotatable manner, and has a screw 5b formed over the all length thereof. The base end side of the extended shaft portion 5 is retained in the the connection member 1b. Therein a flow rate regulating screw 5a with a fine pitch is formed as a damming structure so as to form a shallow screw groove and minimize the clearance from the casing 1. In the a flow rate regulating screw 5a, it is enabled to regulate the flow rate of passing blending components to a minimum and to sufficiently conduct kneading.

The foregoing constitution forms the twin-screw portion 6 wherein the first and second shafts 3, 4 are placed in parallel in the casing 1, and the single-screw portion 7 comprising the extended shaft portion 5 also therein. In the vicinity of the base end portions of each of the first and second shafts 3, 4, there is formed a material feed port 8 communicating with the twin-screw portion 6. The blending components are transmitted to the material feed port 8 from a feeding unit (not shown in the drawing).

The extended shaft portion 5 in the casing 1 is equipped on the side of a tip portion 9 with a discharge port 10 for the composition, and further is equipped on the side of the base portion with a vent for volatiles 32 and also a valve portion 11, having the following constitution.

First of all, an empty chamber 14 is formed at the tip side of the transmitting screw portion 4a, and a passageway 16 with a small diameter is installed in part of the empty chamber 14 to allow the empty chamber 14 to communicate with the cylinder 21. The inside of the empty chamber 14 is such that allows a cylindrical valve body 15 to penetrate therethrough and also enables it to advance and retreat in the direction of the arrow H. The volume of the empty chamber 14 decreases as the valve body 15 approaches the passageway 16, thus throttling the flow passage of the blending components.

The valve portion 11 allows the twin-screw portion 6 to communicate with the single-screw portion 7, and regulates the flow rate of the molten resin which is about to reach the single-screw portion 7 by bypassing the same. The second shaft 4 is equipped at an end with the transmitting screw portion 4a so as to collect almost all the molten resin that has been dammed up by the flow rate regulating screw 5a, and pressurizingly send the molten resin to the inside of the casing 1 via the valve portion 11.

The flow rate regulating mechanism may be other than the foregoing, and is exemplified by the mechanism wherein a valve body is formed by enabling the first shaft 3 to move in the shaft direction and by forming uneven portions on the first shaft 3 and the casing inside in the circumference thereof. In the following, some description will be given of the action of the above-mentioned continuous kneading extruding unit. The blending components that have been supplied at the material feed port 8 are transmitted in the direction of the arrow G with the screw portion 2 of the first shaft 3 and the second shaft 4, and subjected to mastification with the first rotor portions 12a, 12b, so that the resin is brought to a semi-molten state to increase the density of the resin material. By increasing the density of the resin material in this manner, it is enabled to increase the transporting capacity of the resin in the second screws 2a, 2b to enhance the extrusion rate, when the numbers of revolutions of the first shaft 3 and the second shaft 4 are each 10 to 1500 rpm.

The resin material which has been transmitted with the second screws 2a, 2b is completely molten and kneaded in the second rotor portions 13a, 13b. The resin material which has been molten and kneaded is transmitted into the empty chamber 14 with the transmitting screw portion 4a, while the flow rate thereof is regulated with the valve body 15, is passed through the the passageway 16, and is transmitted into the casing 1. By regulating the flow rate thereof in this manner, it is enabled to regulate the retention time for kneading the blending components in the twin-screw kneading portion 6 and the degree of filling of the blending components, whereby the degree of kneading can be freely set by operating the valve portion 11. Thus, by controlling the degree of opening of the valve portion 11 according to the conditions of the resin, it is enabled to impart always uniform kneading to the blending components.

By installing two pairs of rotor portions comprising the first rotor portions 12a, 12b and second rotor portions 13a, 13b it is enabled to intensify the resin melting and kneading action and markedly increase the extrusion rate. Moreover, the flow rate regulating screw 5a and the transmitting screw portion 4a each in the connection member 1b are supported independently of each other, and bearing action is caused by the resin which is filled in the space among the screw 5a, screw portion 4a and cylinders 22, 23, and therefore it is enabled to prevent each of the screws from causing scuffing or galling in high revolutional speed region.

The resin composition which has been molten, kneaded and regulated in the above-mentioned manner is transmitted to the single-screw portion 7, volatiles therein are removed at need through the vent for volatiles 32, and thereafter the resin is transmitted in turn through the extended shaft portion 5, and is extruded through the discharge port 10.

Of the compositions obtainable by the process according to the Invention I, the composition composed of polypropylene as the thermoplastic resin and talc as the filler is well suited as a composition for constituting interior and outerior members of an automobile which require high performance. Further, according to the process of the Invention I, a master batch is obtainable in which a filler is filled in high concentration, and is quite useful as a material for interior and outerior members of an automobile and as a material for electrical home appliance which materials require a master batch in which talc is filled in high concentration. In the meanwhile, the conventional master batch is produced by a gelation process, and thus is devoid of freedom in blending. Concretely, the possibility of granulation upon gelling is restricted by the blending composition, and further rubber base master batch is difficult to produce. As opposed to the foregoing, the production process according to the Invention I, which is not restricted by the blending composition, enables any desirable blending according to the purpose of use thereof.

The thermoplastic resin to be used in the Invention II, which is exemplified by the same as exemplified in the Invention I, is preferably a polyolefinic resin, especially polypropylene. The thermoplastic resin may be used alone or in combination with at least one other. The fluidity of the thermoplastic resin can be properly and optionally selected according to the purpose of use, and is preferably high, that is, high in terms of melt index (MI). For instance, in the case of using as a master batch, the thermoplastic resin obtained by the production process according to the Invention II, the use of a thermoplastic resin having high fluidity and of polypropylene having high fluidity as a neat resin for diluting the same is preferable, since the productivity is enhanced and besides, filler dispersion is improved without causing deterioration in impact strength of an impactproofing material. Furthermore, in the above-mentioned case, the use of polypropylene having a high melt index (MI) is preferable, since the consumption of an organic peroxide can be saved thus leading to curtailment of production cost.

The MI of thermoplastic resin, which is measured according to JIS K 7210 at a load of 21.2 N at 230° C., is preferably at least 20 g/10 min, more preferably at least 40 g/10 min, particularly preferably at least 60 g/10 min.

In the Invention II, the foregoing thermoplastic resin may be blended with any of natural rubber, synthetic rubber, and thermoplastic elastomers. The synthetic rubber is exemplified by the same as exemplified in the Invention I. The thermoplastic elastomers are exemplified by various thermoplastic elastomers such as olefinic thermoplastic elastomers and styrenic thermoplastic elastomers. It is preferable to use polypropylene as a thermoplastic resin, and mix therewith polyethylene and/or rubber. In this case, the content of polypropylene is preferably at least 40% by mass. The content thereof, when being less than 40% by mass, brings about difficulty to assure high fluidity and a fear of deteriorating the dispersibility of a filler in the case where a thermoplastic resin composition according to the Invention II is used as a master batch and is diluted with a neat resin, followed by molding.

Usable filler may be selected from both organic fillers and inorganic fillers, and exemplified by the same as exemplified in the Invention I. Of these, are preferable inorganic fillers, especially talc. It is also possible to use a compressed filler which is other than talc, and is same as in the Invention I.

The average particle diameter of the filler prior to compression, the bulk specific gravity of the compressed filler, the shape of the compressed filler and the process for producing the compressed filler are each same as in the Invention I. As a filler, talc is most preferable from the viewpoints of its properties satisfying the needs of average particle diameter, bulk specific gravity and shape.

In the Invention II, there are used 50 to 10 parts by mass of the thermoplastic resin and 50 to 90 parts by mass of the compressed filler having a bulk specific gravity of at least 0.4 making a total of 100 parts by mass. The amount of the filler to be used is preferably 55 to 85 parts by mass. The amount of the filler to be used, when being less than 50 parts by mass, leads to less effect on the curtailment of product cost in the case of using the thermoplastic resin composition of the Invention II as a master batch for the purpose of curtailing the product cost; whereas the amount, when being more than 90 parts by mass, leads to frequent deterioration in physical properties of the resin composition due to deteriorated dispersibility of the filler at the time of using the thermoplastic resin composition of the Invention II as a master batch and diluting with a neat resin.

The organic peroxide is exemplified by aromatic organic peroxides and aliphatic organic peroxides. Any of them may be in the form of solid (powder or granular) or liquid. Examples thereof include 1,3-bis-(t-butylperoxyisopropyl)benzene; benzoyl peroxide; t-butyl perbenzoate; t-butyl peracetate; t-butyl peroxyisopropyl carbonate; 2,5-di-methyl-2,5-di-(t-benzoylperoxy)-hexane; 2,5-di-methyl-2,5-di-(t-benzoylperoxy)-hexyne-3; t-butyl-di-peradipate; t-butylperoxy-3,5,5-trimethylhexanoate; methyl-ethyl-ketone peroxide; cyclohexanone peroxide; di-t-butyl peroxide; dicumyl peroxide; 2,5-di-methyl-2,5-di-(t-butylperoxy)-hexane; 2,5-di-methyl-2,5-di-(t-butylperoxy)-hexyne-3; t-butylcumyl peroxide; 1,1-bis-(t-butylperoxy)-3,3,5-trimethylcyclohexane; 1,1-bis-(t-butylperoxy)cyclohexane; 2,2-bis-(t-butylperoxy)-butane; p-menthane hydroperoxide; di-iso-propylbenzene hydroperoxide; cumene hydroperoxide; t-butyl hydroperoxide; p-cymene hydroperoxide; 1,1,3,3-tetra-methylbutyl hydroperoxide; and 2,5di-methyl-2,6-di-(hydroperoxy)hexane.

In the Invention II, the organic peroxide may be properly and optionally selected according to melt kneading conditions for the thermoplastic resin composition. The melt kneading is carried out usually at a temperature of 160° C. or higher. The amount of the organic peroxide to be added is 0.008 to 0.2 part by mass, preferably 0.01 to 0.1 part by mass based on 100 parts by mass of total amount of the above mentioned thermoplastic resin and filler. When the amount thereof is less than 0.008 part by mass based thereon, the productivity of the thermoplastic resin composition is not stabilized in high concentration region or when use is made of a filler having a small particle diameter and besides, the dispersibility of the filler is not assured upon molding the thermoplastic resin composition by diluting the same with a neat resin. On the contrary, even when the amount thereof is more than 0.2 part by mass based thereon, the effect is not enhanced in particular, causing nothing but an increase in product cost.

It is preferable from the viewpoints of quality stability and safety to use the organic peroxide by impregnating it into calcium carbonate powder. In this case, when the amount of the organic peroxide is 40% by mass based on the total of the organic peroxide and the calcium carbonate, the amount of the calcium carbonate impregnated therewith can be made to 0.02 to 0.5 part by mass, preferably 0.025 to 0.25 part by mass based on 100 parts by mass of the total of the foregoing thermoplastic resin and filler.

The composition relating to the Invention II can properly and optionally be incorporated with any of an anti-oxidant, weatherproofing agent and pigment in accordance with the purpose of use of the thermoplastic resin composition.

There is usable in the production process according to the Invention II as a kneading extruder, a single-screw kneading extruder, a twin-screw kneading extruder or a kneading extruder equipped with a twin-screw kneading portion and a single-screw extrusion portion. The kneading extruding is carried out preferably by supplying a thermoplastic resin and an organic peroxide to a kneading extruder, kneading the resultant mixture, and then supplying a filler to the kneading extruder. In the Invention II as is the case with the Invention I, it is preferable to employ a kneading extruder which is composed of a twin-screw kneading portion equipped with screws each having an L/D (ratio of length to diameter) of at least 12 in a twin-screw portion, and equipped at an end of the twin-screw portion with a damming structure, and of a single-screw extrusion portion. The description of the kneading extruder, which is the same as in the Invention I, is omitted herein.

A gelation process or Banbury kneading method has hitherto been used as a production process for a master batch. In the case of producing a master batch containing an organic peroxide, the gelation process, although capable of adding the organic peroxide in the granulation step after gelling, is incapable of exhibiting the effect of the present invention, since resin decomposition with the organic peroxide is not accelerated due to a feed material which has already been highly concentrated. Likewise the Banbury kneading method is incapable of exhibiting the desirable effect, since the kneading is conducted at around the melting point of the resin, whereby resin decomposition with the organic peroxide is not accelerated.

Conversely, the thermoplastic resin composition according to the Invention II is obtained through the production process as described hereinbefore. Of the compositions obtainable by the process according to the Invention II, the composition composed of polypropylene as the thermoplastic resin and talc as the filler is well suited as a composition for constituting interior and outerior members of an automobile which require high performance. In addition, the thermoplastic resin composition obtainable according to the process of the Invention II, wherein a filler is filled in high concentration, can be used as a master batch. This master batch is quite useful as a material for interior and outerior members of an automobile and as a material for electrical home appliance which materials require a master batch in which talc is filled in high concentration. Specific examples of the interior and outerior members of an automobile include instrument panels, door trims, console boxes, sheet back trays, side collision preventive members, bumpers, garnishes and the like. This master batch is particularly useful for instrument panels, door trims and bumpers. The thermoplastic resin composition of the Invention II is usable not only for the aforesaid interior and outerior members of an automobile, but also for housings of electrical products, furniture, articles of daily use, miscellaneous goods and the like. When it is used for interior and outerior members of an automobile, it is preferable to form a crimped face.

In the case of using the thermoplastic resin composition of the Invention II as a master batch, the composition is dry blended with a neat resin so as to dilute the master batch on molding such as injection molding, so that the composition is molded. By the term “neat resin” is meant a resin composed principally of the resin similar to the resin constituting the master batch, and in which an other resin may be mixed. In this case, the physical properties of the master batch as obtained by the production process of the Invention II are not deteriorated even if a molding machine is not equipped with a mixing nozzle. However, in the case of coloring the composition on molding by the use of a pigment for the master batch, a molding machine is preferably equipped with a mixing nozzle to prevent the tendency to cause unevenness in dispersibility of the pigment.

The thermoplastic resin and rubber that are to be used as a master batch in the Invention III are exemplified by the same as exemplified in the Invention I.

The filler to be used in the Invention III is exemplified by the same as exemplified in the Invention I, and is preferably an inorganic filler, especially talc. It is also possible to use a compressed filler which is other than talc, and is same as in the Invention I.

The average particle diameter of the filler prior to compression, the bulk specific gravity of the compressed filler, the shape of the compressed filler and the process for producing the compressed filler are each same as in the Invention I. As a filler in the Invention III, talc is most preferable from the viewpoints of its properties satisfying the needs of average particle diameter, bulk specific gravity and shape.

In the Invention III, the filling amount (content in master batch) of the filler is preferably at least 20% by mass, more preferably in the range of 40 to 90% by mass, particularly preferably in the range of 50 to 80% by mass. The filling amount of the filler to be used, when being less than 20% by mass, brings about a fear of insufficient effect on the curtailment of product cost.

The process (I) for producing a thermoplastic resin composition of the Invention III comprises dry blending at least two master batches each formed by melt kneading at least a thermoplastic resin and/or rubber and a filler (at least one of the aforesaid two master batches uses a compressed filler as a filler) and one or at least two neat resins.

The process (II) for producing a thermoplastic resin composition of the Invention III comprises dry blending a master batch formed by melt kneading at least a thermoplastic resin and/or rubber and a compressed filler; and one or at least two neat resins.

The production process according to the Invention III is advantageous in that a typical master batch, when prepared in advance, can be readily formulated into a desirable composition, and can supply a composition at a low cost without being passed through a kneading step. By the term “neat resin” is meant a resin which is composed principally of the resin similar to the resin constituting the master batch, and in which an other resin may be mixed therein.

The master batch is preferably of a binary system which comprises one species of resin or rubber and one species of filler from the standpoint of general availability. The thermoplastic resin composition of the Invention III is formulated into a chemical composition for an objective resin composition. In the case however, where it is not possible to formulate into a chemical composition which is same as that for an objective resin composition, the problem can be solved by altering the chemical composition of the neat resin to such extent that the practical applicability is not problematic. Moreover, since the master batch in relation to the Invention III is based on the precondition of natural color specification, a pigment is blended at the time of blending of the master batch and the neat resin. Preferably, a master batch pigment is suitable and excellent in dispersibility.

Any of the thermoplastic resin compositions that are obtainable by dry blending can be molded by means of injection molding, extrusion molding, blow molding or the like. In the case of injection molding, the physical properties of the master batch obtained thereby are not deteriorated even if a molding machine is not equipped with a mixing nozzle. However, in the case of coloring the composition on molding by the use of a pigment for the master batch, a molding machine is preferably equipped with a mixing nozzle to prevent the tendency to cause unevenness in dispersibility of the pigment. Each feed material may be fed to a molding machine via a fixed delivery feeder.

The composition relating to the Invention III can properly and optionally be incorporated with any of an organic peroxide, anti-oxidant, weatherproofing agent, antistatic agent and pigment according to the purpose of use of the thermoplastic resin composition. Any of the aforesaid additives is charged preferably in the master batch.

The following description is related mainly to the thermoplastic resin, but is also applicable to rubber. Preferably, the specific master batch relating to the Invention III is produced by the use of a a kneading extruder which is composed of a twin-screw kneading portion equipped with screws each having an L/D (ratio of length to diameter) of at least 12 in a twin-screw portion, and equipped at an end of the twin-screw portion with a damming portion, and of a single-screw extrusion portion. The description of the kneading extruder, which is the same as in the Invention I, is omitted herein.

Of the compositions obtainable by the process according to the Invention III, the composition composed of polypropylene as the neat resin and talc as the filler is well suited as a composition for constituting interior and outerior members of an automobile which require high performance. In addition, the master batch relating to the Invention III, wherein a filler is filled in high concentration is quite useful as a material for interior and outerior members of an automobile and as a material for electrical home appliance which materials require a master batch in which talc is filled in high concentration. In the meanwhile, the the conventional master batch is produced by a gelation process, and thus is devoid of freedom in blending. Concretely, the possibility of granulation upon gelling is restricted by the blending composition, and further rubber base master batch is difficult to produce. As opposed to the above, the production process according to the Invention III, which is not restricted by the blending composition, enables any desirable blending according to the purpose of use of the master batch.

By virtue of using the above-mentioned master batch in the production process, the Invention III is advantageous in that a kneading step can be dispensed with, thus enabling to cut off the kneading cost; since it is only needed to administrate master batch and control the natural color, the type of the master batch can be concentrated; if only a crude feed is established, it is possible to immediately confirm the physical properties and the moldability and prepare the same into a desirable chemical composition; in the case where improvement is needed during production, it is possible to confirm the same in situ and alter the chemical composition; thus allowance of feed material enables the master batch to be concentrated into high performance products (for instance, high purity talc, fine talc, highly crystalline polypropylene); and thus it is possible to focus on high level feed materials.

The thermoplastic resins in the component (A) or (B) in the Invention IV are exemplified by the same as exemplified in the Invention I, and are preferably olefinic resins, especially polyethylene and polypropylene. Two species of thermoplastic resins, when used in the component (A), may be the same or different, and the same applies to the component (B). The rubber in the component (A) or (B) in the Invention IV is exemplified by the same as exemplified in the Invention I.

The filler in the master batch (A) of the Invention IV is exemplified by the same as exemplified in the Invention I, and is preferably an inorganic filler, especially talc. It is also possible to use a compressed filler which is other than talc, and is same as in the Invention I.

The average particle diameter of the filler prior to compression, the bulk specific gravity of the compressed filler, the shape of the compressed filler and the process for producing the compressed filler are each same as in the Invention I. As a filler, talc is most preferable from the viewpoints of its properties satisfying the needs of average particle diameter, bulk specific gravity and shape.

As the master batch (A) in the Invention IV, use is made of a composition which comprises 80 to 10 parts by mass of at least two species selected from the thermoplastic resins and rubber, 20 to 90 parts by mass of the filler, thus making a total of 100 parts by mass. The amount of the filler to be used, when being less than 20 parts by mass, leads to less effect on curtailment of production cost, whereas said amount, when being more than 90 parts by mass, brings about such defect that the dispersibility of the filler is deteriorated upon dilution of the master batch with the component (B), thereby causing deterioration in the physical properties of the master batch.

In the production process according to the Invention IV, it is necessary that, when the mass of the component (A) is set on A, and that of the component (B) is set on B, the proportion of the component (A) to the component (B) satisfies the relationship A/(A+B)=0.1 to 0.6, preferably 0.15 to 0.5. The value of A/(A+B), when being less than 0.1, results in deterioration in the quality stability of molded articles, whereas the value, when being more than 0.6, leads to less effect on curtailment of production cost.

The material for molded articles relating to the Invention IV can properly and optionally be incorporated with any of an organic peroxide, anti-oxidant, weatherproofing agent, antistatic agent and pigment according to the purpose of use of the material. Any of these additives is charged preferably in the master batch.

Preferably, the master batch to be used in the Invention IV is produced by the use of a a kneading extruder which comprises a twin-screw kneading portion equipped with screws each having an L/D (ratio of length to diameter) of at least 12 in a twin-screw portion, and equipped at an end of the twin-screw portion with a damming portion; and a single-screw extrusion portion. The description of the kneading extruder, which is the same as in the Invention I, is omitted herein.

Preferable master batch to be used in the Invention IV is that which is produced by the aforesaid process.

Of the master batches obtainable by the process according to the Invention IV, the master batch composed of polypropylene as the thermoplastic resin and talc as the filler is well suited as a master batch for constituting interior and outerior members of an automobile which require high performance. In general, the master batch is molded by dry blending and diluting with a neat resin at the time of injection molding. By the term “neat resin” is meant a resin which is composed principally of the resin similar to the resin constituting the master batch, and in which an other resin may be mixed therein. In the Invention IV, the neat resin is referred to as the component (B). In the case of injection molding, the physical properties of the master batch obtained thereby are not deteriorated even if a molding machine is not equipped with a mixing nozzle. However, in the case of coloring the composition on molding by the use of a pigment for the master batch, a molding machine is preferably equipped with a mixing nozzle to prevent the tendency to cause unevenness in dispersibility of the pigment. In the case of using at least two species as the component (B), it is preferable to supply the component (B) to a molding machine via a fixed delivery feeder.

The material for molded articles according to the Invention IV can be produced by mixing the components (A) and (B) and the above-mentioned additives to be used at need, and molding the resultant mixture by means of injection molding, extrusion molding, blow molding or the like molding method in the case of extrusion molding, profile extrusion is preferable. The molded articles according to the Invention IV can be made into an optional form such as a sheet, and are suitable as interior and outerior members of an automobile, specifically, instrument panels (sometimes abbreviated to “In Pane”), anti-scratch trims, console boxes, sheet back trays, side collision preventive members, bumpers, garnishes and the like. This molded articles are particularly suitable as instrument panels, anti-scratch trims and bumpers.

The In Pane has hitherto been produced by post adding rubber to the material. However according to the process of the Invention IV, rubber can be charged into a master batch, and accordingly the conventional polypropylene (PP) can be used as a neat resin, thereby enabling curtailment of production cost. In addition, according to the process of the Invention IV it is made possible to obtain a material which is suitable as bumper materials, and which comprises two species of PP (two species of block PP), two species of rubber and talc and a material which is suitable as anti-scratch trim materials, and which comprises two species of PP (block PP and homo PP), HDPE and talc.

The molded articles according to the Invention IV can be preferably used not only as the above-mentioned interior and outerior members of an automobile, but also as housings of electrical products, furniture, articles of daily use, miscellaneous goods and the like.

The present invention will be described in more detail with reference to comparative examples and working examples, which however shall never limit the present invention thereto.

### EXAMPLE 1 AND COMPARATIVE EXAMPLES 1 TO 3

### Composition of PP 73/Rubber 4/Talc 23 Each in % by Mass

A thermoplastic resin composition was prepared by blending 73% by mass of polypropylene (manufactured by Idemitsu Petrochemical Co., Ltd. under the trade name “J-762 HP”), 4% by mass of ethylene-octene 1 copolymer rubber (manufactured by Du Pont Dow Elastomer Co., Ltd. under the trade name “EG8842”) and 23% by mass of talc (manufactured by Fuji Talc Industrial Co., Ltd. under the trade name “TP-A25”). As the talc, use was made of non-compressed talc as such (bulk specific gravity of 0.14) or granular talc which had been compressed with a roller compactor (manufactured by Kurimoto Co., Ltd. under the trade name “MRCP”) up to a bulk specific gravity of 0.70 (In Table 1, referred to as “0.70 talc” and the same applies hereinafter). The bulk specific gravity was determined by a method in which the talc in question was poured into a 560 cm³ metering cup until the cup was wholly filled in therewith, the cup was gently tapped, and thereafter a measurement was made of the weight of the talc equivalent to the volume thereof.

The above-prepared resin composition was kneaded by the use of a kneading extruder integrally equipped with a twin-screw kneading portion and a single-screw extruding portion (D=50 mm, L/D=22, manufactured by C.T.E. Corporation under the trade name “HTM”, hereinafter sometimes abbreviated to “HTM”) or a single screw extruder (D=50 mm, manufactured by Nakatani Machine Manufacturing Co., Ltd. under the trade name “NVC”, hereinafter sometimes abbreviated to “NVC”), and extruded into the form of pellet. The kneading extruding by means of the HTM was carried out at a kneading temperature of 220° C. and the number of screw revolutions of 300 rpm, and the kneading extruding by means of the NVC was carried out at a kneading temperature of 220° C. and the number of screw revolutions of 100 rpm. During the kneading, samples of pellets were collected for 3 minutes and weighed to determine the throughput by expressing in terms of collected amount per one hour.

In regard to the aforesaid HTM type twin screw continuous kneading extruder, the screw was of the type of non-meshing and different rotational direction, had double threaded construction and was equipped at an end of the twin screw kneading portion with the foregoing damming structure and an orifice regulating function which regulates the flow rate of the resin. Thus the throughput of the resin was regulated with the damming structure and the orifice regulating function, while the degree of orifice opening was set on 100% in Example 1. In regard to the NVC type single-screw extruder, the screw was of Dulmage type.

The pellet thus obtained was molded by using an injection molding machine (manufactured by Nissei Plastic Industrial Co., Ltd. under the trade name “FE 120”) under the conditions of a molding temperature of 220° C. and a mold temperature of 50° C., so that samples were prepared and evaluated for physical properties according to the following procedure. The results are given in Table 1. Both the flexural modulus of elasticity and throughput indicated high values in Example 1, but showed lower values in Comparative Examples 1 to 3 than in Example 1.

[Evaluation of Physical Properties]

(1) Melt Index (MI)

By using the pellet, melt index was measured according to JIS K 7210 at 230° C. at a load of 21,2 N.

(2) Flexural Modulus of Elasticity

Flexural modulus of elasticity was measured according to JIS K 7171 at a flexural speed of 5 mm/min and a span of 100 mm.

(3) Izod Impact Strength

Izod impact strength was measured according to JIS K 7171.

(4) Whiteness

Whiteness was measured according to JIS K 7105.

TABLE 1

| | | HTM | | NVC | |
|---|---|---|---|---|---|
| | | | Compara've | Compara've | Compara've |
| | | Example 1 | Example 1 | Example 2 | Example 3 |
| Testing | | 0.70 | non-compressed | 0.70 | non-compressed |
| Items | Unit | talc | talc | talc | talc |
| MI | g/10 min | 12 | 12 | 12 | 12 |
| Flexural | MPa | 2910 | 2820 | 2580 | 2530 |
| modulus | | | | | |
| of | | | | | |
| elasticity | | | | | |
| IZOD | kJ/m² | 53 | 54 | 55 | 54 |
| impact | | | | | |
| strength | | | | | |
| Through- | kg/hr | 250 | 200 | 60 | 35 |
| put | | | | | |

{Remarks}
Compara've: Comparative

### EXAMPLE 2 AND COMPARATIVE EXAMPLE 4

### Composition of PP 40/Talc 60 Each in % by Mass

A thermoplastic resin composition was prepared by blending 40% by mass of polypropylene (manufactured by Idemitsu Petrochemical Co., Ltd. under the trade name “J-784 HP”) and 60% by mass of compressed granular talc which had been compressed in the same manner as in Example 1 up to a bulk specific gravity of 0.70. The above-prepared resin composition was kneaded by the use of the above-mentioned HTM or a kneading extruder in which a kneading portion and extruding portion were each composed of a shaft same as each other, and the screws of the twin-screw extruding portion were of the type of meshing and same rotational direction (D=45 mm, L/D=32 without damming structure manufactured by Ikegai Machine Tool Co., Ltd. under the trade name “PCM”, hereinafter sometimes abbreviated to “PCM”), and extruded into the form of pellet. The kneading extruding with the PCM was conducted at a kneading temperature of 230° C. and the number of screw revolutions of 150 rpm. Then, pellets samples were collected in the same manner as in Example 1, and evaluated for physical properties. The results are given in Table 2. As can be seen from Table 2, the flexural modulus of elasticity showed a lower value in Comparative Example 4 than in Example 2.

TABLE 2

| | | Example 2 | Comparative Example 4 |
|---|---|---|---|
| | | HTM | PCM |
| Testing Items | Unit | 0.70 talc | 0.70 talc |
| Flexural modulus of | MPa | 9400 | 8900 |
| elasticity | | | |
| IZOD impact strength | kJ/m² | 2.6 | 2.6 |

### EXAMPLE 3 AND COMPARATIVE EXAMPLE 5

### Diluted Product of Composition Containing 60% by Mass of Talc

The thermoplastic resin composition containing 60% by mass of talc which had been obtained in Example 2 and Comparative Example 4, respectively was used as a master batch, and 50% by mass of polypropylene (manufactured by Idemitsu Petrochemical Co., Ltd. under the trade name “J-784 HP”) and 50% by mass of the aforesaid master batch were dry blended with each other. The resultant blend was molded by means of the injection molding machine as used in Example 1 (but without any mixing nozzle) to prepare samples, which were evaluated for physical properties in the same manner as in Example 1. The results are given in Table 3.

TABLE 3

| | | Example 3 | Comparative Example 5 |
|---|---|---|---|
| | | HTM | PCM |
| Testing Items | Unit | 0.70 talc | 0.70 talc |
| MI | g/10 min | 15 | 14 |
| Flexural modulus of | MPa | 4690 | 4280 |
| elasticity | | | |
| IZOD impact strength | kJ/m² | 5.9 | 5.8 |

### EXAMPLES 4 & 5 AND COMPARATIVE EXAMPLES 6 TO 8

### Composition of PP 30/Talc 70 Each in % by Mass

A thermoplastic resin composition was prepared by blending 30% by mass of polypropylene (manufactured by Idemitsu Petrochemical Co., Ltd. under the trade name “J-784 HP”) and 70% by mass of non-compressed talc (bulk specific gravity of 0.14) or compressed granular talc which had been compressed in the same manner as in Example 1 up to a bulk specific gravity of 0.70 or 0.98. The above-prepared resin composition was kneaded by the use of the above-mentioned HTM, PCM or a tandem type kneading extruder equipped with a damming structure (D=130 mm, L/D=5, manufactured by Cosmotic Co., Ltd. under the trade name “CCM”, hereinafter sometimes abbreviated to “CCM”), and extruded into the form of pellet. The kneading extruding by using the HTM was conducted at a kneading temperature of 220° C. and the number of screw revolutions of 300 rpm; that by using the PCM was conducted at a kneading temperature of 230° C. and the number of screw revolutions of 150 rpm; and that of the CCM was conducted at a kneading temperature of 240° C. and the number of screw revolutions of 300 rpm. Pellets samples were obtained from HTM, but were not obtainable from both PCM and CCM.

The blending components were subjected to a gelation process by which the components were allowed to gel at 180° C. with a Henschel mixer, transferred to a cooling tank, and made into pellets with a granulator. Then, samples were prepared by using the pellets just mentioned and the foregoing pellets, and evaluated for physical properties in the same manner as in Example 1. The results are given in Table 4. As can be seen from Table 4, the flexural modulus of elasticity and whiteness revealed lower values in the samples prepared by the gelation process than those prepared with HTM.

TABLE 4

| | | HTM | | Comparative Example No. | | |
|---|---|---|---|---|---|---|
| | | Example No. | | 6 | 7 | 8 |
| | | 4 | 5 | PCM | CCM | gelation |
| Testing | | 0.70 | 0.98 | 0.70 | 0.70 | non-compressed |
| Items | Unit | talc | talc | talc | talc | talc |

| | | | | | |
|---|---|---|---|---|---|
| Flexural | MPa | 11300 | 11260 | Non- | 9300 |
| modulus of | | | | producible | |
| elasticity | | | | | |
| IZOD | kJ/m² | 1.8 | 1.9 | | 1.9 |
| strength | | | | | |
| Whiteness | — | 80 | 80 | | 66 |
| Through- | kg/hr | 140 | 150 | | — |
| put | | | | | |

### EXAMPLES 6 & 7 AND COMPARATIVE EXAMPLE 9

### Diluted Product of Composition Containing 70% by Mass of Talc

The thermoplastic resin composition containing 70% by mass of talc which had been obtained in the foregoing was used as a master batch, and 57% by mass of polypropylene (manufactured by Idemitsu Petrochemical Co., Ltd. under the trade name “J-784 HP”) and 43% by mass of the aforesaid master batch were dry blended with each other. The resultant blend was molded by means of the injection molding machine as used in Example 1 (but without any mixing nozzle) to prepare samples, which were evaluated for physical properties in the same manner as in Example 1, The results are given in Table 5.

TABLE 5

| | | | | Comparative |
|---|---|---|---|---|
| | | | | Example 9 |
| | | HTM | | gelation |
| | | Example 6 | Example 7 | non-compressed |
| Testing Items | Unit | 0.70 talc | 0.98 talc | talc |
| MI | g/10 min | 15 | 15 | 12 |
| Flexural | MPa | 4560 | 4530 | 4320 |
| modulus of | | | | |
| elasticity | | | | |
| IZOD impact | kJ/m² | 6.1 | 5.6 | 5.5 |
| strength | | | | |
| Whiteness | — | 80 | 80 | 69 |

### EXAMPLE 8 AND COMPARATIVE EXAMPLE 10

### Composition Containing 80% by Mass of Talc

A thermoplastic resin composition was prepared by blending 20% by mass of polypropylene (manufactured by Idemitsu Petrochemical Co., Ltd. under the trade name “J-6071 HP”) and 80% by mass of compressed granular talc which had been compressed in the same manner as in Example 1 up to a bulk specific gravity of 0.70. The above-prepared resin composition was kneaded by the use of the above-mentioned HTM, but was impossible to granulate. The composition in which use was made of granular talc having a bulk specific gravity of 0.98 instead of 0.70 was possible to granulate (Example 8). The composition in which use was made of non-compressed talc instead of granular talc having a bulk specific gravity of 0.70 was impossible to granulate with the HTM (Comparative Example 10). In this case, the term “impossible to granulate” means that the resin was not molten, and the filler spouted from a die at the tip of an extruder.

### EXAMPLE 9 AND COMPARATIVE EXAMPLE 11

### Composition Containing 30% by Mass of Ruber and 70% by Mass of Talc

A rubber composition (rubber master batch) was prepared by kneading extruding 30% by mass of ethylene-octene 1 copolymer rubber (manufactured by Du Pont Dow Elastomer Co., Ltd. under the trade name “EG8842”) and 70% by mass of granular talc which had been compressed in the same manner as in Example 1 up to a bulk specific gravity of 0.70 by the use of the above-mentioned HTM. Subsequently, 70% by mass of polypropylene (manufactured by Idemitsu Petrochemical Co., Ltd. under the trade name “J-784 HP”) and 30% by mass of the above-prepared rubber master batch were dry blended with each other, and molded by using the injection molding machine as used in Example 1 (but without any mixing nozzle) to prepare samples (diluted product), which were evaluated for physical properties in the same manner as in Example 1. In addition, 70% by mass of polypropylene (manufactured by Idemitsu Petrochemical Co., Ltd. under the trade name “J-784 HP”) and 9% by mass of ethylene-octene 1 copolymer rubber (manufactured by Du Pont Dow Elastomer Co., Ltd. under the trade name “EG8842”) and 21% by mass of non-compressed talc same as the foregoing (bulk specific gravity of 0.14) were kneaded and extruded into pellets by means of the NVC. The resultant pellets were injection molded in the same manner as the foregoing to prepare samples, which were evaluated for physical properties in the same manner as in Example 1. The results are given in Table 6. As can be seen from Table 6, the rubber molded article prepared by using the master batch produced according to the process of the Invention I possesses physical properties comparable to those of the rubber molded article prepared by the conventional production process without the use of a master batch.

TABLE 6

| | | Example 9 | Comparative Example 11 |
|---|---|---|---|
| | | diluted | totally blended |
| Testing Items | Unit | product | product |
| MI | g/10 min | 9 | 9 |
| Flexural modulus | MPa | 2890 | 2870 |
| of elasticity | | | |
| IZOD impact strength | kJ/m² | 41 | 43 |

### EXAMPLE 10 AND COMPARATIVE EXAMPLES 12

### Composition of PP 73/Rubber 4/Talc 23 Each in % by Mass

A thermoplastic resin composition was prepared by blending 73% by mass of polypropylene (manufactured by Idemitsu Petrochemical Co., Ltd. under the trade name “J-762 HP”), 4% by mass of ethylene-octene 1 copolymer rubber (manufactured by Du Pont Dow Elastomer Co., Ltd. under the trade name “EG8842”) and 23% by mass of talc (manufactured by Fuji Talc Industrial Co., Ltd. under the trade name “TP-A25”). As the talc, use was made of talc in the form of chip which had been compressed with the roller compactor as used in Example 1, and granulated with a granulator in the subsequent step and which had a major axis of about 7 mm and a bulk specific gravity of 0.78. The above-prepared resin composition was kneaded and extruded into the form of pellet in the same manner as in Example 1, or with a CCM. The kneading extruding by means of the CCM was carried out at a kneading temperature of 240° C. and the number of screw revolutions of 300 rpm. During the kneading, samples of pellets were prepared in the same manner as in Example 1, and were evaluated for physical properties. The results are given in Table 7.

When the HTM was used, almost the same physical properties were obtained irrespective of the shape of the compressed talc (granular or chip form). On the other hand, when the CCM was used, both the flexural modulus of elasticity and IZOD impact strength indicated low values, whereby it is understood that the low values were due to the influence of the talc in the form of chip. External appearance of any of the samples was favorable without any poor appearance due to agglomeration of talc.

TABLE 7

| | | HTM | | C/Example 12 |
|---|---|---|---|---|
| | | Example 1 | Example 10 | CCM |
| | | 0.70 talc | 0.78 talc | 0.78 talc |
| Testing Items | Unit | granular | chip form | chip form |
| MI | g/10 min | 12 | 12 | 14 |
| Flexural | MPa | 2910 | 2900 | 2620 |
| modulus of | | | | |
| elasticity | | | | |
| IZOD impact | kJ/m² | 53 | 45 | 30 |
| strength | | | | |

{Remarks}
C/Example: Comparative Example

### EXAMPLES 11 TO 15 AND COMPARATIVE EXAMPLES 13 TO 17

There was used as a thermoplastic resin, block polypropylene (manufactured by Idemitsu Petrochemical Co., Ltd. under the trade name “J-3053 HP”, MI: 30 g/10 min) or block polypropylene (manufactured by Idemitsu Petrochemical Co., Ltd. under the trade name “J-6071 HP”, MI: 70 g/10 min). The method for measuring MI will be described hereinafter. There was used as a filler, talc which had an average particle diameter of 4.5 μm and a bulk specific gravity of 0.14 (manufactured by Fuji Talc Industrial Co., Ltd. under the trade name “TP-A25”), and which had been compressed with a roller compactor (manufactured by Kurimoto Co., Ltd. under the trade name “MRCP”) up to a bulk specific gravity of 0.35, 0.70 or 1.0 (in Table 8, referred to as “0.35 talc” and so forth). The bulk specific gravity was determined by a method in which the talc in question was poured into a 560 cm³ metering cup until the cup was wholly filled in therewith, the cup was gently tapped, and then a measurement was made of the weight of the talc equivalent to the volume thereof. There were used as a dispersant, magnesium stearate (in Table 8, referred to as “Mg-St”, and the same applies hereinafter); as an anti-oxidant, a phenolic anti-oxidant (manufactured by CibaGeigy Speciality Chemicals Co., Ltd. under the trade name “Irganox”) (in Table 8, referred to as “Irg-1010”, and the same applies hereinafter); as an organic peroxide, 40 parts by mass of 1, 3-bis-(t-butylperoxyisopropyl)benzene impregnated into 60 parts by mass of calcium carbonate (manufactured by Kayaku-AKZO Corporation under the trade name “P-14-40C”).

The thermoplastic resin was mixed with the organic peroxide and incorporated with the talc and the above-described additives to form a mixture, which was used for kneading extruding. That is to say, the mixture was kneaded by the use of a kneading extruder integrally equipped with a twin-screw kneading portion and a single-screw extruding portion (D=50 mm, L/D=22, manufactured by C.T.E. Corporation under the trade name “HTM”, hereinafter sometimes abbreviated to “HTM”) and extruded into the form of pellet. The kneading extruding by means of the HTM was carried out at a kneading temperature of 220° C. and the number of screw revolutions of 300 rpm.

In regard to the aforesaid HTM type twin-screw continuous kneading extruder, the screw was of the type of non-meshing and different rotational direction, had double threaded construction and was equipped at an end of the twin screw kneading portion with the damming structure as described above and an orifice regulating function which regulates the flow rate of the resin. The throughput of the resin was regulated with the damming structure and the orifice regulating function, while the degree of orifice opening was set on 100%.

Aside from the foregoing, the blending components were subjected to a gelation process by which the components were allowed to gel at 180° C. with a Henschel mixer, transferred to a cooling tank, and made into pellets by means of a granulator (Comparative Example 15).

In Table 8 are given the loss rate and productivity of the composition thus obtained. In the case where the composition is continuously supplied to a cutting apparatus and pelletized by strand cut, when the composition is cut off during the supply thereof to the cutting apparatus, it is obliged to discard the cut portion and conduct the continuous supply all over again, starting with another composition, thereby causing a loss. In general, since approximately 2% loss occurs for cleaning the kneading extruder at the startup thereof, when the composition is continuously supplied to a cutting apparatus without any trouble, the loss rate is approximately 2%. It is understood from Table 8 that in Examples 11 & 13, the composition is free from loss in the case where it is supplied to the apparatus, and that in Comparative Example 13, wherein pellets were prepared in the same manner as in Example 11 except that the use of an organic peroxide was omitted, the loss rate is high because of low dispersibility of the talc. When use is made of plural talc having same bulk specific gravity, difference in the loss rate is affected by use and non-use of an organic peroxide. Such difference is obvious from the comparison between Example 13 and Comparative Example 16, between Example 14 and Comparative Example 17 and between Example 15 and Comparative Example 18. Comparative Example 15, wherein the thermoplastic resin composition was prepared by a gelation process, an organic peroxide was added thereto in a granulation step after gelation, and the resultant product was used in Comparative Example 20 as a master batch, revealed low values in every respects of fluidity (MI), flexural modulus of elasticity and IZOD impact strength as can be seen from Table 9-1.

The strand cut is a method in which a composition is cooled in a conventional water tank, and thereafter cut into pellets with a strand cutter. In this method, when talc having a high concentration is used, the strand is more prone to be cut off, whereby strand cut is made difficult. As a countermeasure there-against, there is adopted a hot cut method in which a die is equipped at its outlet with a cutter so that extruded material is pelletized immediately after extrusion. Thus, in the present examples and comparative Examples, the hot cut method was adopted in the case of a talc concentration being 80% by mass. The productivity (kg/hr) is expressed by the throughput of the of pellet in weight per one hour.

TABLE 8-1

| Blending Component | | | | | |
|---|---|---|---|---|---|
| (parts by mass) | Ex 11 | C/Ex 13 | C/Ex 14 | Ex 12 | C/Ex 15 |
| J-3053 HP | 40 | 40 | 40 | 40 | 40 |
| J-6071 HP | | | | | |
| 0.35 talc | | | 60 | | |
| 0.70 talc | | | | 60 | |
| 1.0 talc | 60 | 60 | | | 60 |
| Mg-St | 0.5 | 0.5 | 0.5 | 0.5 | 0.5 |
| Irg-1010 | 0.2 | 0.2 | 0.2 | 0.2 | 0.2 |
| P-40-40C | 0.1 | 0 | 0.1 | 0.1 | 0.1 |
| Loss rate of | 2 | 19 | 77 | 5 | 2 |
| composition (%) | | | | | |
| Productivity | 210 | 200 | 125 | 185 | — |
| (kg/hr) | | | | | |

| | |
|---|---|
| Pelletizing method | strand cut method |

{Remarks}
Ex: Example,
C/Ex: Comparative Example

TABLE 8-2

| Blending Component | | | | | | |
|---|---|---|---|---|---|---|
| (parts by mass) | Ex 13 | C/Ex 16 | Ex 14 | C/Ex 17 | Ex 15 | C/Ex 18 |
| J-3053 HP | | | | | | |
| J-6071 HP | 40 | 40 | 30 | 30 | 20 | 20 |
| 0.35 talc | | | | | | |
| 0.70 talc | | | | | | |
| 1.0 talc | 60 | 60 | 70 | 70 | 80 | 80 |
| Mg-St | 0.5 | 0.5 | 0.5 | 0.5 | 0.5 | 0.5 |
| Irg-1010 | 0.2 | 0.2 | 0.2 | 0.2 | 0.2 | 0.2 |
| P-40-40C | 0.1 | 0 | 0.1 | 0 | 0.1 | 0 |
| Loss rate of | 2 | 14 | 6 | 38 | 2 | 2 |
| composition (%) | | | | | | |
| Productivity | 220 | 210 | 180 | 165 | 145 | 130 |
| (kg/hr) | | | | | | |

| | | |
|---|---|---|
| Pelletizing method | strand cut method | hot cut method |

{Remarks}
Ex: Example,
C/Ex: Comparative Example

### EXAMPLES 16 TO 20, COMPARATIVE EXAMPLES 19 TO 23 AND REFERENCE EXAMPLES 1 & 2

The components as given in Table 9 were dry blended, and the blend was molded by using an injection molding machine (manufactured by Nissei Plastic Industrial Co., Ltd. under the trade name “FE 120”) under the conditions of a molding temperature of 220° C., an injection time of 12 seconds, a back pressure of 20%, a mold temperature of 50° C., a cooling time of 20 sec and absence of a mixing nozzle so that samples were prepared and evaluated for physical properties according to the following procedure. The results are given in Table 9.

In the examples and comparative examples, the thermoplastic resin compositions obtained in Examples 11 to 15 and Comparative Examples 13 and 15 to 18 were each used as a master batch, which was diluted with a neat resin and injection molded. There were used as neat resins, block polypropylene (manufactured by Idemitsu Petrochemical Co., Ltd. under the trade name “J-6071 HP”, MI: 70 g/10 min) and ethylene-octene 1 copolymer rubber (manufactured by Du Pont Dow Elastomer Co., Ltd. under the trade name “EG8100”). In Reference Example 1, the blending components that were the same as in Examples 16, 17 except that an organic peroxide was not contained, were wholly blended, kneaded and molded. Likewise in Reference Example 2, the blending components that were the same as in Examples 18 were used. In Reference Examples 1, 2, non-compressed talc as a filler was used which had an average particle diameter of 4.5 μm and a bulk specific gravity of 0.14 (manufactured by Fuji Talc Industrial Co., Ltd. under the trade name “TP-A25”).

It is understood from Table 9, that the injection molded articles in Examples 16, 17 have balanced physical properties comparable to those of the injection molded articles in Reference Example 1 which were prepared without the use of a master batch. Comparison between Example 18 and Reference Example 2 allows to understand the same as the foregoing. The injection molded articles in Comparative Examples 19 and 21 to 23 in which the thermoplastic resin compositions obtained in Comparative Examples 13 and 16 to 18 were used as master batches are not so inferior in physical properties to those of Examples. However, as can be seen from Table 8, it can not be said that the productivity is favorable because of high loss rate. The injection molded article in Comparative Example 20 in which the thermoplastic resin composition prepared in Comparative Example 15 was used as a master batch was inferior particularly in flexural modulus of elasticity.

[Evaluation of Physical Properties]

(1) Melt Index (MI)

By using the pellet, melt index was measured according to JIS K 7210 at 230° C. at a load of 21.2 N.

(2) Flexural Modulus of Elasticity

Flexural modulus of elasticity was measured according to JIS K 7171 at a flexural speed of 5 mm/min and a span of 100 mm.

(3) Izod Impact Strength

Izod impact strength was measured according to JIS K 7171.

TABLE 9-1

| Blending Component | | | | | | | |
|---|---|---|---|---|---|---|---|
| (parts by mass) | | R/Ex 1 | Ex 16 | C/Ex 19 | Ex 17 | C/Ex 20 | R/Ex 2 |
| J-6071 HP | | 51.7 | 51.7 | 51.7 | 51.7 | 51.7 | 67 |
| EG-1800 | | 10 | 10 | 10 | 10 | 10 | 10 |
| J-3053 HP | | 15.3 | | | | | |
| TP-A25 | | 23.0 | | | | | 23.0 |
| Mg-St | | 0.2 | | | | | 0.2 |
| Irg-1010 | | 0.1 | | | | | 0.1 |
| MB in Ex 11 | | | 38.3 | | | | |
| MB in Ex 12 | | | | | 38.3 | | |
| MB in Ex 13 | | | | | | | |
| MB in Ex 14 | | | | | | | |
| MB in Ex 15 | | | | | | | |
| MB in C/Ex 13 | | | | 38.3 | | | |
| MB in C/Ex 15 | | | | | 38.3 | | |
| MB in C/Ex 16 | | | | | | | |
| MB in C/Ex 17 | | | | | | | |
| MB in C/Ex 18 | | | | | | | |
| Testing | | | | | | | |
| Items | Unit | | | | | | |
| MI | g/10 min | 34 | 38 | 35 | 38 | 30 | 40 |
| Flexural modulus | MPa | 2550 | 2610 | 2600 | 2580 | 2480 | 2680 |
| of elasticity | | | | | | | |
| IZOD impact | kJ/m² | 23 | 20 | 15 | 21 | 12 | 14 |
| strength | | | | | | | |

{Remarks}
Ex: Example,
C/Ex: Comparative Example,
R/Ex: Reference Example,
MB: Master batch

TABLE 9-2

| Blending Component | | | | | | | |
|---|---|---|---|---|---|---|---|
| (parts by mass) | | Ex 18 | C/Ex 21 | Ex 19 | C/Ex 22 | Ex 20 | C/Ex 23 |
| J-6071 HP | | 51.7 | 51.7 | 57.1 | 57.1 | 61.2 | 61.2 |
| EG-1800 | | 10 | 10 | 10 | 10 | 10 | 10 |
| J-3053 HP | | | | | | | |
| TP-A25 | | | | | | | |
| Mg-St | | | | | | | |
| Irg-1010 | | | | | | | |
| MB in Ex 11 | | | | | | | |
| MB in Ex 12 | | | | | | | |
| MB in Ex 13 | | 38.3 | | | | | |
| MB in Ex 14 | | | | 32.9 | | | |
| MB in Ex 15 | | | | | | 28.8 | |
| MB in C/Ex 13 | | | | | | | |
| MB in C/Ex 15 | | | | | | | |
| MB in C/Ex 16 | | | 38.3 | | | | |
| Ms in C/Ex 17 | | | | | 32.9 | | |
| MB in C/Ex 18 | | | | | | | 28.8 |
| Testing | | | | | | | |
| Items | (Unit) | | | | | | |
| MI | (g/10 min) | 45 | 41 | 42 | 40 | 40 | 38 |
| Flexural modulus | (MPa) | 2700 | 2680 | 2720 | 2650 | 2750 | 2640 |
| of elasticity | | | | | | | |
| IZOD impact | (kJ/m²) | 12 | 9 | 13 | 10 | 11 | 8 |
| strength | | | | | | | |

{Remarks}
Ex: Example,
C/Ex: Comparable Example,
R/Ex: Reference Example,
MB: Master batch

### PREPARATION EXAMPLES 1 TO 12

### Preparation of Master Batch

There was used as a thermoplastic resin, polypropylene manufactured by Idemitsu Petrochemical Co., Ltd. under the trade name “J-3000 GP”), polypropylene (manufactured by Idemitsu Petrochemical Co., Ltd. under the trade name “J-784 HP”) or polyethylene (manufactured by Idemitsu Petrochemical Co., Ltd. under the trade name “210 JZ”). There was used as rubber, ethylene-octene 1 copolymer rubber (manufactured by Du Pont Dow Elastomer Co., Ltd. under the trade name “EG8842”). There was used as a filler, non-compressed talc having an average particle diameter of 4.5 μm as such (bulk specific gravity of 0.14) or granular talc which had been compressed with a roller compactor manufactured by Kurimoto Co., Ltd. under the trade name “MRCP”) up to a bulk specific gravity of 0.70 (In Table 10, referred to as “0.70 talc” and the same applies hereinafter), sedimentable barium sulfate having an average particle diameter of 0.86 μm (manufactured by Barite Industrial Co., Ltd. under the trade name “Tinbari ST”) or heavy calcium carbonate having an average particle diameter of 1.43 g In (manufactured by Dohwa Calfine Industrial Co., Ltd. under the trade name “Christon SS”). The bulk specific gravity was determined by a method in which the talc in question was poured into a 560 cm³ metering cup until the cup was wholly filled in therewith, the cup was gently tapped, and then a measurement was made of the weight of the talc equivalent to the volume thereof. In Table 10, a filler blending amount in parenthesis shows the use of a non-compressed filler. There were used as a dispersant, magnesium stearate (In Table 10, referred to as “Mg-St” and the same applies hereinafter); and as an anti-oxidant, a phenolic antioxidant (manufactured by Ciba-Geigy Speciality Chemicals Co., Ltd. under the trade name “Irganox”) (in Table 10, referred to as “Irg-1010”, and the same applies hereinafter).

The above-described components were kneaded by the use of a kneading extruder integrally equipped with a twin-screw kneading portion and a single-screw extruding portion (D=50 mm, L/D=22, manufactured by C.T.E. Corporation under the trade name “HTM”, hereinafter sometimes abbreviated to “HTM”) and extruded into the form of pellet. The kneading extruding by means of the HTM was carried out at a kneading temperature of 220° C. and the number of screw revolutions of 300 rpm.

In regard to the aforesaid HTM type twin-screw continuous kneading extruder, the screw was of the type of non-meshing and different rotational direction, had double threaded construction and was equipped at an end of the twin-screw kneading portion with the foregoing damming structure and an orifice regulating function which regulates the flow rate of the resin. The throughput of the resin was regulated with the damming structure and the orifice regulating function, while the degree of orifice opening was set on 100%.

Aside from the foregoing, the blending components were subjected to a gelation process by which the blending components were allowed to gel at 180° C. with a Henschel mixer, transferred to a cooling tank, and made into pellets with a granulator (Preparation Examples 7 to 12). In Table 10, regarding the “Producibility” the mark “◯” means producible, whereas the mark “x” means unproducible; and the “Filling amount of filler (%)” means the proportion of filler (% by mass) in pellets.

TABLE 10-1

| | HTM kneader was used | | | | | |
|---|---|---|---|---|---|---|
| Blending Components | No. of Preparation Example | | | | | |
| (parts by mass) | 1 | 2 | 3 | 4 | 5 | 6 |
| J-3000 GP | 30 | 20 | 30 | | | |
| J-784 HP | | | | 30 | | |
| EG 8842 | | | | | 30 | |
| 210 JZ | | | | | | 30 |
| 0.70 talc | 70 | | | 70 | 70 | 70 |
| Tinbari ST | | (80) | | | | |
| Christon SS | | | (70) | | | |
| Mg-St | 0.5 | 0.5 | 0.5 | 0.5 | 0.5 | 0.5 |
| Irg-1010 | 0.2 | 0.2 | 0.2 | 0.2 | 0.2 | 0.2 |
| Producibility | ◯ | ◯ | ◯ | ◯ | ◯ | ◯ |
| Filling amount | 44 | 44 | 44 | 44 | 43 | 45 |
| of filler (%) | | | | | | |

TABLE 10-2

| | Gelation was used | | | | | |
|---|---|---|---|---|---|---|
| Blending Components | No. of Preparation Example | | | | | |
| (parts by mass) | 7 | 8 | 9 | 10 | 11 | 12 |
| J-3000 GP | 30 | 20 | 30 | | | |
| J-784 HP | | | | 30 | | |
| EG 8842 | | | | | 30 | |
| 210 JZ | | | | | | 30 |
| 0.70 talc | (70) | | | (70) | (70) | (70) |
| Tinbari ST | | (80) | | | | |
| Christon SS | | | (70) | | | |
| Mg-St | 0.5 | 0.5 | 0.5 | 0.5 | 0.5 | 0.5 |
| Irg-1010 | 0.2 | 0.2 | 0.2 | 0.2 | 0.2 | 0.2 |
| Producibility | ◯ | ◯ | ◯ | X | X | X |
| Filling amount of | 44 | 44 | 44 | — | — | — |
| filler (%) | | | | | | |

### EXAMPLE 21

There were used the master batch which had been obtained in Preparation Example 1, and polypropylene (manufactured by Idemitsu Petrochemical Co., Ltd. under the trade name “J-3000 GP” and “J-2003 GP”) as neat resins. The above-mentioned master batch and polypropylene were dry blended at a blending ratio as given in Table 11, wherein master batch is abbreviated to “MB”, and the blend was molded by using an injection molding machine (manufactured by Nissei Plastic Industrial Co., Ltd. under the trade name “FE 120”) in the conditions of a molding temperature of 220° C., an injection time of 12 seconds, a back pressure of 1.5 MPa, a mold temperature of 50° C., a cooling time of 20 sec and absence of a mixing nozzle so that samples were prepared and evaluated for physical properties according to the following procedure. The results are given in Table 11.

[Evaluation of Physical Properties]

(1) Melt Index (MI)

By using the pellet, melt index was measured according to JIS K 7210 at 230% at a load of 21.2 N.

(2) Flexural Modulus of Elasticity

Flexural modulus of elasticity was measured according to JIS K 7171 at a flexural speed of 5 mm/min and a span of 100 mm.

(3) Izod Impact Strength

Izod impact strength was measured according to JIS K 7171.

### COMPARATIVE EXAMPLE 24

### Conventional Blend

The blending components in Table 11 that were blended so that the feed materials and the compositional ratio thereof were equalized to those of the molded samples in Example 21, were made into pellets by means of the above-mentioned HTM type twin-screw continuous kneading extruder. By using the resultant pellets, samples were prepared in the same manner as in Example 21, and evaluated for physical properties according to the foregoing procedure. The results are given in Table 11.

### COMPARATIVE EXAMPLE 25

The master batch which had been prepared through a gelation process by using non-compressed talc as a filler (Preparation Example 7) so that the feed materials and the compositional ratio thereof were equalized to those of the molded samples in Example 21, were made into pellets. By using the resultant pellets, samples were prepared in the same manner as in Example 21, and evaluated for physical properties according to the foregoing procedure. The results are given in Table 11.

As can be seen from Table 11, the composition in Example 21 has physical properties comparable to those of the composition in Comparative Example 24 which was obtained by the conventional process, whereas the composition in Comparative Example 25 has poor dispersibility and thus is inferior in physical properties to those of the same because of the master batch produced by the gelation process.

TABLE 11

| Blending Components (parts by mass) | | Ex 21 | C/Ex 24 | C/Ex 25 |
|---|---|---|---|---|
| MB in Preparation Example 1 | | 24.3 | | |
| MB in Preparation Example 7 | | | | 24.3 |
| J-3000 GP | | 32.7 | 40 | 32.7 |
| J-2003 GP | | 43 | 43 | 43 |
| 0.70 talc | | | 17 | |
| Mg-St | | | 0.12 | |
| Irg-1010 | | | 0.05 | |
| Testing Items | Unit | | | |
| MI | g/10 min | 23 | 24 | 19 |
| Flexural modulus of | MPa | 3640 | 3620 | 3320 |
| elasticity | | | | |
| IZOD impact strength | kJ/m² | 3.8 | 3.8 | 3.1 |

{Remarks}
Ex: Example,
C/Ex: Comparative Example

### EXAMPLE 22

The procedure in Example 21 was repeated to prepare samples and evaluate physical properties except that there were used the master batch as obtained in Preparation Examples 1 & 2 and polypropylene (manufactured by Idemitsu Petrochemical Co., Ltd. under the trade name “J-903 GP”) as a neat resin, which were dry blended at the blending ratio as given in Table 12. The results are given in Table 12.

### COMPARATIVE EXAMPLE 26

### Conventional Blend

The blending components in Table 12 that were blended so that the feed materials and the compositional ratio thereof were equalized to those of the molded samples in Example 22, were made into pellets by means of the above-mentioned HTM type twin-screw continuous kneading extruder. By using the resultant pellets, samples were prepared in the same manner as in Example 21, and evaluated for physical properties according to the foregoing procedure. The results are given in Table 12.

### COMPARATIVE EXAMPLE 27

There were used non-compressed talc as a filler; the master batch which had been prepared through a gelation process (Preparation Example 7); and the master batch which had been prepared through a gelation process (Preparation Example 8) by using Tinbari ST as a filler so that the feed materials and the compositional ratio thereof were equalized to those of the molded samples in Example 22. Thus pellets samples were prepared in the same manner as in Example 21, and evaluated for physical properties according to the foregoing procedure. The results are given in Table 12.

TABLE 12

| Blending Components (parts by mass) | | Ex 22 | C/Ex 26 | C/Ex 27 |
|---|---|---|---|---|
| MB in Preparation Example 1 | | 2.9 | | |
| MB in Preparation Example 2 | | 10 | | |
| MB in Preparation Example 7 | | | | 2.9 |
| MB in Preparation Example 8 | | | | 10 |
| J-903 GP | | 87.1 | 90 | 87.1 |
| Tinbari ST | | | 8 | |
| 0.70 talc | | | 2 | |
| Mg-St | | | 0.07 | |
| Irg-1010 | | | 0.03 | |
| Testing Items | Unit | | | |
| MI | g/10 min | 16 | 16 | 16 |
| Flexural modulus of | MPa | 2440 | 2430 | 2200 |
| elasticity | | | | |
| IZOD impact strength | kJ/m² | 5.3 | 5.5 | 4.4 |

{Remarks}
Ex: Example,
C/Ex: Comparative Example

### EXAMPLE 23

The procedure in Example 21 was repeated to prepare samples and evaluate physical properties except that there were used the master batch as obtained in Preparation Examples 1 & 3 and polypropylene (manufactured by Idemitsu Petrochemical Co., Ltd. under the trade name “J-2000 GP”) as a neat resin, which were dry blended at the blending ratio as given in Table 13. The results are given in Table 13.

### COMPARATIVE EXAMPLE 28

### Conventional Blend

The blending components in Table 13 that were blended so that the feed materials and the compositional ratio thereof were equalized to those of the molded samples in Example 23, were made into pellets by means of the above-mentioned HTM type twin-screw continuous kneading extruder. By using the resultant pellets, samples were prepared in the same manner as in Example 21, and evaluated for physical properties according to the foregoing procedure. The results are given in Table 13.

### COMPARATIVE EXAMPLE 29

There were used non-compressed talc as a filler; the master batch which had been prepared through a gelation process (Preparation Example 7); and the master batch which had been prepared through a gelation process (Preparation Example 9) by using Christon SS as a filler so that the feed materials and the compositional ratio thereof were equalized to those of the molded samples in Example 23. Thus pellets samples were prepared in the same manner as in Example 21, and evaluated for physical properties according to the foregoing procedure. The results are given in Table 13.

TABLE 13

| Blending Components (parts by mass) | | Ex 23 | C/Ex 28 | C/Ex 29 |
|---|---|---|---|---|
| MB in Preparation Example 1 | | 10 | | |
| MB in Preparation Example 3 | | 20 | | |
| MB in Preparation Example 7 | | | | 10 |
| MB in Preparation Example 9 | | | | 20 |
| J-3000 GP | | | 21 | |
| J-2000 GP | | 58 | 58 | 58 |
| 0.70 talc | | | 7 | |
| Christon SS | | | 14 | |
| Mg-St | | | 0.2 | |
| Irg-1010 | | | 0.1 | |
| Testing Items | Unit | | | |
| MI | g/10 min | 17 | 18 | 13 |
| Flexural modulus of | MPa | 2970 | 2950 | 2610 |
| elasticity | | | | |
| IZOD impact strength | kJ/m² | 4.1 | 4.1 | 3.4 |

{Remarks}
Ex: Example,
C/Ex: Comparative Example

### Example 24

The procedure in Example 21 was repeated to prepare samples and evaluate physical properties except that there were used the master batch as obtained in Preparation Examples 4 & 5 and polypropylene (manufactured by Idemitsu Petrochemical Co., Ltd. under the trade name “J-466 HP”) as a neat resin, which were dry blended at the blending ratio as given in Table 14. The results are given in Table 14.

### COMPARATIVE EXAMPLE 30

### Conventional Blend

The blending components in Table 14 that were blended so that the feed materials and the compositional ratio thereof were equalized to those of the molded samples in Example 24, were made into pellets by means of the above-mentioned HTM type twin-screw continuous kneading extruder. By using the resultant pellets, samples were prepared in the same manner as in Example 21, and evaluated for physical properties according to the foregoing procedure. The results are given in Table 14.

As can be seen from Table 14, the composition in Example 24 has physical properties comparable to those of the composition in Comparative Example 30 which was obtained by the conventional production process.

TABLE 14

| Blending Components (parts by mass) | | Ex 24 | C/Ex 30 |
|---|---|---|---|
| MB in Preparation Example 4 | | 6.2 | |
| MB in Preparation Example 5 | | 26.7 | |
| J-784 HP | | | 54 |
| J-466 HP | | 15 | 15 |
| EG 8842 | | | 8 |
| TP-A25 | | | 23 |
| Mg-St | | 0.2 | 0.2 |
| Irg-1010 | | | 0.17 |
| Testing Items | Unit | | |
| MI | g/10 min | 8 | 9 |
| Flexural modulus of elasticity | MPa | 2760 | 2750 |
| IZOD impact strength | kJ/m² | 57 | 53 |

{Remarks}
Ex: Example,
C/Ex: Comparative Example

### EXAMPLE 25

The procedure in Example 21 was repeated to prepare samples and evaluate physical properties except that there were used the master batches as obtained in Preparation Examples 1 & 6 and polypropylene (manufactured by Idemitsu Petrochemical Co., Ltd. under the trade name “J-6071 HP” and “J-3000 GP”) each as a neat resin, which were dry blended at the blending ratio as given in Table 15. The results are given in Table 15.

### COMPARATIVE EXAMPLE 31

### Conventional Blend

The blending components in Table 15 that were blended so that the feed materials and the compositional ratio thereof were equalized to those of the molded samples in Example 25, were made into pellets by means of the above-mentioned HTM type twin-screw continuous kneading extruder. By using the resultant pellets, samples were prepared in the same manner as in Example 21, and evaluated for physical properties according to the foregoing procedure. The results are given in Table 15.

As can be seen from Table 15, the composition in Example 25 has physical properties comparable to those of the composition in Comparative Example 31 which was obtained by the conventional production process.

TABLE 15

| Blending Components (parts by mass) | | Ex 25 | C/Ex 31 |
|---|---|---|---|
| MB in Preparation Example 1 | | 4.7 | |
| MB in Preparation Example 6 | | 16.7 | |
| J-6071 HP | | 65 | 65 |
| J-3000 GP | | 13.6 | 15 |
| 210 JZ | | | 5 |
| TP-A25 | | | 15 |
| Mg-St | | | 0.11 |
| Testing Items | Unit | | |
| MI | g/10 min | 60 | 62 |
| Flexural modulus of elasticity | MPa | 2300 | 2320 |
| IZOD impact strength | kJ/m² | 5.9 | 5.7 |

{Remarks}
Ex: Example,
C/Ex: Comparative Example

### PREPARATION EXAMPLES 13 TO 18

### Preparation of Master Batch

There was used as a thermoplastic resin, block polypropylene (manufactured by Idemitsu Petrochemical Co., Ltd. under the trade name “J-762H”), block polypropylene (manufactured by Idemitsu Petrochemical Co., Ltd. under the trade name “J-6071 HP” homopolypropylene (manufactured by Idemitsu Petrochemical Co., Ltd. under the trade name “J-3000 GP”) or high density polyethylene (manufactured by Idemitsu Petrochemical Co., Ltd. under the trade name “210 JZ”). There was used as rubber, ethylene-octene 1 copolymer rubber (manufactured by Du Pont Dow Elastomer Co., Ltd. under the trade name “EG-8100”) or ethylene propylene copolymer rubber (manufactured by JSR Corporation under the trade name “EP07-P”). There was used as a filler, non-compressed talc having an average particle diameter of 4.5 μm as such (bulk specific gravity of 0.14) (manufactured by Fuji Talc Industrial Co., Ltd. under the trade name “TP-A25”) or granular talc which had been compressed with a roller compactor (manufactured by Kurimoto Co., Ltd. under the trade name “MRCP”) up to a bulk specific gravity of 1.0 (In Table 16, referred to as “1.0 talc” and the same applies hereinafter), The bulk specific gravity was determined by a method in which the talc in question was poured into a 560 cm³ metering cup until the cup was wholly filled in therewith, the cup was gently tapped, and then a measurement was made of the weight of the talc equivalent to the volume thereof. There was used as an organic peroxide, 40 parts by mass of 1,3-bis-(t-butylperoxyisopropyl)benzene impregnated into 60 parts by mass of calcium carbonate (manufactured by Kayaku AKZO Corp. under the trade name “P-14-40C”). There was used as a pigment, dark gray color pigment (manufactured by Tokyo Ink MFG. Co., Ltd. under the trade name “NH-283L Color”) or black master batch pigment (60% by mass of low density polyethylene/40% by mass of carbon black, manufactured by Cabot Co., Ltd. under the trade name “PE 2272”). The blending amount of the pigment was regulated to the chemical composition of the final blending. There were used as a dispersant, magnesium stearate (In Table 16, referred to as “Mg-St” and the same applies hereinafter); and as an anti-oxidant, a phenolic antioxidant (manufactured by Ciba-Geigy Speciality Chemicals Co., Ltd. under the trade name “Irganox”) (in Table 16, referred to as “Irg-1010”, and the same applies hereinafter). Preparation Examples 13 to 15, 16 and 17, and 18 relate to master batch for an In Pane, a bumper, and an anti-scratch trim, respectively.

The above-described components were kneaded by the use of a kneading extruder integrally equipped with a twin screw kneading portion and a single screw extruding portion (D=50 mm, L/D=22, manufactured by C.T.E. Corporation under the trade name “HTM”, hereinafter sometimes abbreviated to “HTM”) and extruded into the form of pellet (Preparation Examples 13, 14, and 16 to 18). The kneading extruding by means of the HTM was carried out at a kneading temperature of 220° C. and the number of screw revolutions of 300 rpm.

In regard to the aforesaid HTM type twin-screw continuous kneading extruder, the screw was of the type of non-meshing and different rotational direction, had double threaded construction and was equipped at an end of the twin-screw kneading portion with the foregoing damming structure and an orifice regulating function which regulates the flow rate of the resin. The throughput of the resin was regulated with the damming structure and the orifice regulating function, while the degree of orifice opening was set on 100%.

Aside from the foregoing, the blending components were subjected to a gelation process by which the blending components were allowed to gel at 180° C. with a Henschel mixer, transferred to a cooling tank, and made into pellets with a granulator (Preparation Example 15).

TABLE 16

| | Preparation Example No. | | | | | |
|---|---|---|---|---|---|---|
| | | | | | | Anti- |
| | IN Pane | | | Bumper | | scratch |
| Blending Components | HTM | | Gelation | HTM | | trim |
| (parts by mass) | 13 | 14 | 15 | 16 | 17 | 18 |
| PP (J-762 HP) | 9 | 9 | 9 | | | |
| PP (J-6071 HP) | | | | 2 | 2 | |
| PP (J-3000 GP) | | | | | | 33.3 |
| HDPE (210 JZ) | | | | | | 16.7 |
| Rubber (EG-8100) | 21 | 21 | 21 | | | |
| Rubber (EG-07P) | | | | 28 | 28 | |
| Compressed talc | 70 | 70 | | 70 | 70 | 50 |
| (1.0 talc) | | | | | | |
| Talc (TP-A25) | | | 70 | | | |
| P-14-40C | | | | | | 0.2 |
| Dark gray dry color | | 4.2 | | | | |
| pigment | | | | | | |
| (NH-283Lcolor) | | | | | | |
| Black master batch | | | | | 5.2 | 2 |
| pigment (PE 2272) | | | | | | |
| Mg-St | 0.35 | 0.35 | 0.35 | 0.35 | 0.35 | 0.33 |
| Irg-1010 | 0.35 | 0.35 | 0.35 | 0.35 | 0.35 | 0.33 |

### EXAMPLES 26 TO 28 AND COMPARATIVE EXAMPLES 32 TO 34

### Molded Article for In Pane

The components as given in Table 17 were dry blended and supplied to an injection molding machine (manufactured by Nissei Plastic Industrial Co., Ltd. under the trade name “FE 120”) to mold the components in the conditions of a molding temperature of 220° C., an injection time of 12 seconds, a back pressure of 20% (10% in the case of whole blending), an injection speed of 50%, an injection pressure being minimum filling pressure+10%, a mold temperature of 50° C. and a cooling time of 20 sec, to prepare samples. In addition, use was made of a fixed delivery feeder {manufactured by Satoh Industrial Co., Ltd. under the trade name “Simple Color (SC-1N-4P)”: machine mount type}. Thus, evaluations were made of the physical properties of the resultant samples according to the following procedure. The results are given in Table 17, in which the dark gray MB (master batch) pigment (NH-283L color) for dry blend molding was the product of Tokyo Ink Co., Ltd. and in which consideration was given to the dispersibility at the time of dry blending.

In Comparative Examples 33 & 34, wherein the blending was same as that in Example 26, injection molding was conducted by using whole blend components without the use of a master batch.

[Evaluation of Physical Properties]

(1) Melt Index (MI)

A test piece for measuring surface hardness (flat sheet of 75 mm×75 mm×3 mm) was produced by machining, and the melt index was measured according to ASTM D1238.

(2) Flexural Modulus of Elasticity

Flexural modulus of elasticity was measured according to JIS K 7171 at a flexural speed of 5 mm/min and a span of 100 mm.

(3) Izod Impact Strength

Izod impact strength was measured according to JIS K 7171.

(4) Presence of Color Shading

A test piece (75 mm×75 mm×3 mm) was visually checked for color shading.

TABLE 17-1

| | | | | Comp. Example No. | | |
|---|---|---|---|---|---|---|
| Blending Components | Example No. | | | | whole blend | |
| (parts by mass) | 26 | 27 | 28 | 32 | 33 | 34 |
| PP (J-762 HP) | 71.4 | 71.4 | 71.4 | 71.4 | (74) | (74) |
| Rubber (EG-8100) | | | | | (6) | (6) |
| Talc (TP-A25) | | | | | (20) | (20) |
| Mg-St | | | | | (0.1) | (0.1) |
| Irg-1010 | | | | | (0.1) | (0.1) |
| Dark gray MB | 3 | | | 3 | 3 | 3 |
| pigment for dry | | | | | | |
| blend mold'g | | | | | | |
| MB in Pre/Example 13 | 28.6 | | | | | |
| MB in Pre/Example 14 | | 28.6 | 28.6 | | | |
| MB in Pre/Example 15 | | | | 28.6 | | |
| Presence of mixing | yes | no | yes | yes | no | yes |
| nozzle in molding | | | | | | |
| machine | | | | | | |
| MB/(MB+ neat resin) | 0.286 | 0.286 | 0.286 | — | — | — |
| Filling concentration | 70 | 70 | 70 | — | — | — |
| of MB (parts by mass) | | | | | | |

{Remarks}
Pre/Example: Preparation Example,
mold'g: molding

TABLE 17-2

| | Example No. | | | Comp. Example No. | | |
|---|---|---|---|---|---|---|
| Testing Items (Unit) | 26 | 27 | 28 | 32 | 33 | 34 |
| MI (g/10 min) | 12 | 14 | 14 | 9 | 11 | 11 |
| Flexural modulus | 2410 | 2490 | 2470 | 2200 | 2380 | 2350 |
| of elasticity (MPa) | | | | | | |
| IZOD Impact strength | 55 | 53 | 59 | 31 | 51 | 57 |
| with notch (kJ/m²) | | | | | | |
| Presence of color | no | no | no | yes | yes | no |
| shading (visual) | | | | | | |
| Minimum filling | 30 | 20 | 27 | 35 | 22 | 32 |
| pressure (%) | | | | | | |

{Remarks}
Comp. Example: Comparative Example

### EXAMPLES 29 TO 31 AND COMPARATIVE examples 35 & 36

### Molded Article for Bumper (ASTM System)

The components as given in Table 18 were dry blended and supplied to an injection molding machine (manufactured by Nissei Plastic Industrial Co., Ltd. under the trade name “FE 120”) to mold the components in the conditions of a molding temperature of 220° C., an injection time of 12 seconds, a back pressure of 20% (10% in the case of whole blending), an injection speed of 50%, an injection pressure being minimum filling pressure+10%, a mold temperature of 50° C. and a cooling time of 20 sec to prepare samples. In addition, use was made of a fixed delivery feeder {manufactured by Satoh Industrial Co., Ltd. under the trade name “Simple Color (SC-1N-4P)”: machine mount type}. Thus, evaluations were made of the physical properties of the resultant samples according to the foregoing procedure. The results are given in Table 18, in which the black MB (master batch) pigment for dry blend molding was the product of Cabot Co., Ltd. and in which consideration was given to the dispersibility at the time of dry blending. IZOD impact strength was measured at −30° C.

In Comparative Examples 35 & 36, wherein the blending was same as that in Example 29, injection molding was conducted by using whole blending components without the use of a master batch.

TABLE 18

| | | | | C/Example No. | |
|---|---|---|---|---|---|
| Blending Components | Example No. | | | 35 | 36 |
| (parLs by mass) | 29 | 30 | 31 | whole blend | |
| PP (J-6071 HP) | 59.4 | 59.4 | 59.4 | (60) | (60) |
| Rubber (EG-8100) | 12 | 12 | 12 | (12) | (12) |
| Rubber (EP-07 P) | | | | (8) | (8) |
| Talc (TP-A25) | | | | (20) | (20) |
| Mg-St | | | | (0.1) | (0.1) |
| Irg-1010 | | | | (0.1) | (0.1) |
| Black MB pigment for dry | 3 | | | 3 | 3 |
| blend molding | | | | | |
| MB in Preparation Example 16 | 28.6 | | | | |
| MB in Preparation Example 17 | | 28.6 | 28.6 | | |
| Presence of mixing nozzle | yes | no | yes | no | yes |
| in molding machine | | | | | |
| MB/(MB+ neat resin) | 0.286 | 0.286 | 0.286 | — | — |
| Filling concentration of | 70 | 70 | 70 | | |
| MB (parts by mass) | | | | | |
| Testing Items (Unit) | 18 | 19 | 19 | 15 | 15 |
| MI (g/10 min) | | | | | |
| Flexural modulus of | 1770 | 1850 | 1810 | 1580 | 1570 |
| elasticity (MPa) | | | | | |
| IZOD Impact strength | 22 | 21 | 22 | 20 | 21 |
| (at-30° C.) | | | | | |
| with notch) (kJ/m²) | | | | | |
| Presence of color shading | no | no | no | yes | no |
| (visual) | | | | | |
| Minimum filling pressure (%) | 21 | 15 | 19 | 17 | 23 |

{Remarks}
Comp. Example: Comparative Example

### EXAMPLES 32 TO 33 AND COMPARATIVE EXAMPLES 37 & 38

{Molded Article for Anti-Scratch Trim (ASTM System)}The components as given in Table 19 were dry blended and supplied to an injection molding machine (manufactured by Nissei Plastic Industrial Co., Ltd. under the trade name “FE 120”) to mold the components in the conditions of a molding temperature of 220° C., an injection time of 12 seconds, a back pressure of 20% (10% in the case of whole blending), an injection speed of 50%, an injection pressure being minimum filling pressure+10%, a mold temperature of 50° C. and a cooling time of 20 sec to prepare samples. Moreover, use was made of a fixed delivery feeder (manufactured by Satoh Industrial Co., Ltd. under the trade name “Simple Color (SC-1N-4P)”: machine mount type). Thus, evaluations were made of the physical properties of the samples according to the following procedure. Specifically, Du Pont impact strength was measured at −30° C. by using a test piece cut into a size of 75 mm×75 mm×3 mm under such conditions as a load of 2 kgf (approximately 19.6 N), an impact core of ½ inch (12.7 mm) in diameter, a catch pan of 2 inches (50.8 mm) in inside diameter. The results are given in Table 19, in which the dark gray MB (master batch) pigment (NH-283 L color) for dry blend molding was the same as that used in Example 26.

In Comparative Examples 37 & 38, wherein the blending was same as that in Example 32, injection molding was carried out by using whole blend components without the use of a master batch.

TABLE 19

| | | | C/Example No. | |
|---|---|---|---|---|
| Blending Components | Example No. | | 37 | 38 |
| (parts by mass) | 32 | 33 | whole blend | |
| PP (J-6071 HP) | 70 | 70 | (70) | (70) |
| PP (J-3000 GP) | | | (10) | (10) |
| HDPE (210 JZ) | | | (5) | (5) |
| Talc (TP-A25) | | | (15) | (15) |
| Mg-St | | | (0.1) | (0.1) |
| Irg-1010 | | | (0.1) | (0.1) |
| Dark gray MB pigment for dry | | | 3 | 3 |
| blend molding | | | | |
| P-14-40C | | | (0.06) | (0.06) |
| MB in Preparation Example 18 | 30 | 30 | | |
| Presence of mixing nozzle | no | yes | no | yes |
| in molding machine | | | | |
| MB/(MB + neat resin) | 0.30 | 0.30 | — | — |
| Filling concentration of | 50 | 50 | | |
| MB (parts by mass) | | | | |
| Testing Items (Unit) | | | | |
| MI (g/10 min) | 70 | 71 | 71 | 71 |
| Flexural modulus of elasticity | 2380 | 2360 | 2280 | 2250 |
| (MPa) | | | | |
| IZOD Impact strength (with | 5.8 | 6.1 | 5.9 | 6.1 |
| notch | | | | |
| (kJ/m²) | | | | |
| Du Pont Impact strength | 6 | 8 | 6 | 8 |
| (at-10° C.) (J) | | | | |
| Presence of color shading | no | no | yes | no |
| (visual) | | | | |
| Minimum filling pressure (%) | 6 | 11 | 8 | 15 |

{Remarks}
C/Example: Comparative Example

### INDUSTRIAL APPLICABILITY

According to the Invention I & II, it is made possible to produce in high productivity, a thermoplastic resin composition which is excellent in the balance among physical properties and contains a filler in high concentration, and which is well suited for use as a master batch.

According to the Invention III, it is made possible to produce a thermoplastic resin composition which has physical properties comparable to those of a composition which is produced by a conventional kneading procedure without using a master batch.

According to the Invention IV, it is made possible to produce at a low cost, a material for molded articles which is capable of coping even with molded articles requiring intricate blending. Thus, molded articles produced by molding the above material for molded articles have favorable external appearance, and are are well suited for use as an interior and exterior member for automobiles.

1. A process for producing a thermoplastic resin composition or a rubber composition which comprises melt kneading at least a thermoplastic resin and/or rubber and a filler by the use of a kneading extruder, wherein a compressed filler is used as a filler and the kneading extruder is composed of a twin-screw kneading portion equipped with screws each having an L/D (ratio of length to diameter) of at least 12 in a twin-screw portion, and equipped at an end of the twin-screw portion with a damming structure, and of a single-screw extrusion portion.

2. The process according to claim 1, wherein the screws in the twin-screw kneading portion are of the type of non-meshing and different rotational direction.

3. The process according to claim 1, wherein the screws in the twin-screw kneading portion comprise double threaded structure.

4. The process according to claim 1, wherein the twin-screw kneading portion is equipped at an end thereof with a function of regulating the flow rate of blending components.

5. The process according to claim 1, wherein the twin-screw kneading portion and the single-screw extrusion portion are integrated with each other.

6. The process according to claim 1, wherein the filler has an average particle diameter of at most 15 μm prior to be compressed.

7. The process according to claim 1, wherein the filler is compressed by a pressurizing treatment or a depressurizing treatment.

8. The process according to claim 1, wherein the compressed filler is in granular form.

9. The process according to claim 1, wherein the filler is talc.

10. The process according to claim 1, wherein the thermoplastic resin is a polyolefin based resin.

11. A thermoplastic resin composition or a rubber composition each being produced by the process as set forth in claim 1.

12. A process for producing a thermoplastic resin composition which comprises kneading extruding 50 to 10 parts by mass of a thermoplastic resin and 50 to 90 parts by mass of a compressed filler having a bulk specific gravity of at least 0.4 making a total of 100 parts by mass in the presence of 0.008 to 0.2 part by mass of an organic peroxide by the use of a single-screw kneading extruder, a twin-screw kneading extruder or a kneading extruder composed of a twin-screw kneading portion and a single-screw extrusion portion.

13. The process according to claim 12, wherein the kneading extrusion is carried out by supplying the kneading extruder with the thermoplastic resin and the organic peroxide, kneading the same and subsequently supplying the kneading extruder with the filler.

14. The process according to claim 12, wherein the kneading extruder composed of a twin-screw kneading portion and a single-screw extrusion portion comprises the twin-screw kneading portion equipped with screws each having an L/D (ratio of length to diameter) of at least 12 in a twin-screw portion, and equipped at an end of the twin-screw portion with a damming structure, and a single-screw extrusion portion.

15. The process according to claim 12, wherein the organic peroxide is impregnated into calcium carbonate.

16. The process according to claims 12, wherein the compressed filler has an average particle diameter of at most 15 μm prior to be compressed.

17. The process according to claim 12, wherein the filler is talc.

18. The process according to claim 12, wherein the thermoplastic resin is a polyolefin based resin.

19. The process according to claim 18, wherein the thermoplastic resin is homopolypropylene, block polypropylene or random polypropylene.

20. A thermoplastic resin composition which is produced by the process as set forth in claim 12.

21. A process for producing a thermoplastic resin composition which comprises dry blending a master batch formed by melt kneading at least a thermoplastic resin and/or rubber and a compressed filler; and at least two neat resins.

22. The process according to claim 21, wherein the master batch comprises the filler in an amount of at least 20% by mass.

23. A process for producing a thermoplastic resin composition which comprises dry blending at least two master batches each formed by melt kneading at least a thermoplastic resin and/or rubber and a filler; and at least two neat resins, wherein a compressed filler is used as a filler in at least one of the aforesaid at least two master batches.

24. The process according to claim 23, wherein the master batch comprises the filler in an amount of at least 20% by mass.

25. The process according to claim 21, wherein the master batch is produced by melt kneading at least a thermoplastic resin and/or rubber and a filler by the use of a kneading extruder which is composed of a twin-screw kneading portion equipped with screws each having an L/D (ratio of length to diameter) of at least 12 in a twin-screw portion, and equipped at an end of the twin-screw portion with a damming structure, and of a single-screw extrusion portion.

26. The process according to claims 21, wherein the compressed filler has an average particle diameter of at most 15 μm prior to be compressed.

27. The process according to claim 21, wherein the filler is compressed by a pressurizing treatment or a depressurizing treatment.

28. The process according to claim 21, wherein the compressed filler is in granular form.

29. The process according to claim 21, wherein the filler is talc.

30. The process according to claim 21, wherein the thermoplastic resin is a polyolefin based resin.

31. A thermoplastic resin composition which is produced by the process as set forth in claim 21.

32. A process for producing a material for molded articles by blending a master batch (A) comprising at least two species selected from the group consisting of thermoplastic resins and rubber and a compressed filler; and at least one species (B) selected from the group consisting of thermoplastic resins and rubber, wherein A {the mass of the component (A)}/[A+B {the mass of the component (B)}] is in the range of 0.1 to 0.6.

33. The process according to claim 32, wherein the master batch is produced by melt kneading at least two species selected from the group consisting of thermoplastic resins and rubber, and fillers by the use of a kneading extruder which is composed of a twin-screw kneading portion equipped with screws each having an L/D (ratio of length to diameter) of at least 12 in a twin-screw portion, and equipped at an end of the twin-screw portion with a damming structure, and of a single-screw extrusion portion.

34. The process according to claim 32, wherein the thermoplastic resin in the component (A) or (B) is selected from the group consisting of polyethylene and polypropylene.

35. The process according to claim 32, wherein the content of the compressed filler in the master batch is in the range of 20 to 90% by mass.

36. The process according to claim 32, wherein the compressed filler contains at least talc.

37. A molded article which is produced by molding the material for molded article by the process as set forth in claim 32.

38. The molded article according to claim 37, wherein the molding is effected by injection molding, extrusion molding or blow molding.
